(19) United States
(12) Patent Application Publication
(10) Pub. No.: US 2026/0189344 A1
(43) Pub. Date: Jul. 2, 2026

(54) CONFIGURING DEMODULATION REFERENCE SIGNAL DENSITY

(71) Applicant: Lenovo (United States) Inc., Morrisville, NC (US)

(72) Inventors: Ahmed Hindy, Aurora, IL (US); Vijay Nangia, Woodridge, IL (US)

(73) Assignee: Lenovo (United States) Inc., Morrisville, NC (US)

(21) Appl. No.: 19/001,944

(22) Filed: Dec. 26, 2024

(51) Int. Cl. H04L 5/00

(52) U.S. Cl. CPC H04L 5/0051; H04L 5/0064; H04L 5/0094

(57) ABSTRACT

Various aspects of the present disclosure relate to configuring demodulation reference signal (DMRS) density. A user equipment (UE) may receive signaling that indicates one or more density values associated with one or more DMRS symbols across a set of resources associated with a physical channel (e.g., a downlink physical channel or an uplink physical channel). The physical channel is associated with a set of layers corresponding to a set of ports of the DMRS symbols. The density values correspond to respective portions of resources of the set of resources occupied by the DMRS symbols. The UE transmits the DMRS symbols via an uplink physical channel or receives the DMRS symbols via a downlink physical channel based on the one or more density values.

### TECHNICAL FIELD

The present disclosure relates to wireless communications, and more specifically to transmitting and receiving reference signals.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive signaling that indicates one or more density values associated with one or more demodulation reference signal (DMRS) symbols across a set of resources associated with a physical channel, where the physical channel is associated with a set of layers corresponding to a set of ports of the one or more DMRS symbols, and where the one or more density values correspond to respective portions of resources of the set of resources occupied by the one or more DMRS symbols, and transmit or receive, via the physical channel, the one or more DMRS symbols based on the one or more density values.

A processor (e.g., a standalone processor chipset, or a component of a UE) for wireless communication is described. The processor may be configured to, capable of, or operable to perform one or more operations as described herein. For example, the processor may be configured to, capable of, or operable to receive signaling that indicates one or more density values associated with one or more DMRS symbols across a set of resources associated with a physical channel, where the physical channel is associated with a set of layers corresponding to a set of ports of the one or more DMRS symbols, and where the one or more density values correspond to respective portions of resources of the set of resources occupied by the one or more DMRS symbols, and transmit or receive, via the physical channel, the one or more DMRS symbols based on the one or more density values.

A method performed or performable by a UE for wireless communication is described. The method may include receiving signaling that indicates one or more density values associated with one or more DMRS symbols across a set of resources associated with a physical channel, where the physical channel is associated with a set of layers corresponding to a set of ports of the one or more DMRS symbols, and where the one or more density values correspond to respective portions of resources of the set of resources occupied by the one or more DMRS symbols, and transmitting or receiving, via the physical channel, the one or more DMRS symbols based on the one or more density values.

In some implementations of the UE, the processor, and the method described herein, the one or more density values include a frequency density value, and where the set of resources includes a set of resource blocks (RBs). In some implementations of the UE, the processor, and the method described herein, the respective portions of the resources include alternating RBs of the set of RBs based on the frequency density value being one half. In some implementations of the UE, the processor, and the method described herein, the one or more density values include a time density value, and where the set of resources includes a set of slots. In some implementations of the UE, the processor, and the method described herein, the respective portions of the resources include alternating slots of the set of slots based on the time density value being one half. In some implementations of the UE, the processor, and the method described herein, the signaling includes one or more parameters that indicate a presence of a DMRS symbol in the respective portions of resources of the set of resources, and where the signaling includes at least one of a downlink control information (DCI) scheduling a physical downlink shared channel (PDSCH), a DCI scheduling a physical uplink shared channel (PUSCH), a semi-persistent scheduling (SPS) PDSCH trigger, a configured grant (CG) PUSCH trigger, a physical downlink control channel (PDCCH) configuration message, or a physical uplink control channel (PUCCH) configuration message.

In some implementations of the UE, the processor, and the method described herein, the UE, the processor, and the method may further be configured to, capable of, or operable to transmit, prior to receiving the signaling, additional signaling that indicates one or more parameters, where the one or more density values are based on the one or more parameters. In some implementations of the UE, the processor, and the method described herein, the additional signaling includes a channel state information (CSI) report, and where the one or more parameters include at least one of a channel flatness factor or a channel coherence period across at least one of a time domain and a frequency domain. In some implementations of the UE, the processor, and the method described herein, a density value of the one or more density values corresponds to a partitioning of the set of resources into two subsets of resources, and where a first subset of resources of the two subsets of resources includes a first numerical quantity (e.g., number, amount) of DMRS symbols per resource, and where a second subset of resources of the two subsets of resources includes a second numerical quantity of DMRS symbols per resource. In some implementations of the UE, the processor, and the method described herein, a ratio of a numerical quantity of resources in the first subset of resources and a total numerical quantity of resources in the set of resources is based on the density value. In some implementations of the UE, the processor, and the method described herein, the signaling includes a quasi-colocation (QCL) relationship that associates a first set of DMRS symbols in the first subset of resources with a second set of DMRS symbols in the second subset of resources, and where the QCL relationship is with respect to one or more characteristics including at least one of an average delay, a delay spread, a Doppler shift, a Doppler spread, a spatial transmit filter or a spatial receive filter.

In some implementations of the UE, the processor, and the method described herein, the first numerical quantity of DMRS symbols per resource associated with the first subset of resources is greater than the second numerical quantity of DMRS symbols per resource associated with the second subset of resources. In some implementations of the UE, the processor, and the method described herein, the second numerical quantity of DMRS symbols per resource is zero. In some implementations of the UE, the processor, and the method described herein, the second subset of resources includes a zero power (ZP) DMRS, where symbols corresponding to the ZP DMRS in the second subset of resources are associated with DMRS symbols in the first subset of resources via a QCL relationship with respect to one or more characteristics, and where the one or more characteristics include at least one of an average delay, a delay spread, a Doppler shift, a Doppler spread, a spatial transmit filter, or a spatial receive filter. In some implementations of the UE, the processor, and the method described herein, the UE, the processor, and the method may further be configured to, capable of, or operable to receive feedback including a negative acknowledgement (NACK) corresponding to a transmitted transport block (TB), or transmit the feedback including the NACK corresponding to a received TB, and transmit or receive one or more additional DMRS symbols based on a default density value associated with the set of ports of the one or more DMRS symbols. In some implementations of the UE, the processor, and the method described herein, the default density value is one. In some implementations of the UE, the processor, and the method described herein, the UE, the processor, and the method may further be configured to, capable of, or operable to apply the default density value to the one or more additional DMRS symbols a time period after the feedback is received or transmitted. In some implementations of the UE, the processor, and the method described herein, the physical channel is a PDSCH, a PDCCH, a PUSCH, or a PUCCH.

An NE (e.g., a base station) for wireless communication is described. The NE may be configured to, capable of, or operable to perform one or more operations as described herein. For example, the NE may be configured to, capable of, or operable to transmit signaling that indicates one or more density values associated with one or more DMRS symbols across a set of resources associated with a physical channel, where the physical channel is associated with a set of layers corresponding to a set of ports of the one or more DMRS symbols, and where the one or more density values correspond to respective portions of resources of the set of resources occupied by the one or more DMRS symbols, and receive or transmit, via the physical channel, the one or more DMRS symbols based on the one or more density values.

A processor (e.g., a standalone processor chipset, or a component of an NE) for wireless communication is described. The processor may be configured to, capable of, or operable to perform one or more operations as described herein. For example, the processor may be configured to, capable of, or operable to transmit signaling that indicates one or more density values associated with one or more DMRS symbols across a set of resources associated with a physical channel, where the physical channel is associated with a set of layers corresponding to a set of ports of the one or more DMRS symbols, and where the one or more density values correspond to respective portions of resources of the set of resources occupied by the one or more DMRS symbols, and receive or transmit, via the physical channel, the one or more DMRS symbols based on the one or more density values.

A method performed or performable by an NE (e.g., a base station) for wireless communication is described. The method may include transmitting signaling that indicates one or more density values associated with one or more DMRS symbols across a set of resources associated with a physical channel, where the physical channel is associated with a set of layers corresponding to a set of ports of the one or more DMRS symbols, and where the one or more density values correspond to respective portions of resources of the set of resources occupied by the one or more DMRS symbols, and receiving or transmitting, via the physical channel, the one or more DMRS symbols based on the one or more density values.

In some implementations of the NE, the processor, and the method described herein, the one or more density values include a frequency density value, and where the set of resources includes a set of RBs. In some implementations of the NE, the processor, and the method described herein, the respective portions of the resources include alternating RBs of the set of RBs based on the frequency density value being one half. In some implementations of the NE, the processor, and the method described herein, the one or more density values include a time density value, and where the set of resources includes a set of slots. In some implementations of the NE, the processor, and the method described herein, the respective portions of the resources include alternating slots of the set of slots based on the time density value being one half. In some implementations of the NE, the processor, and the method described herein, the signaling includes one or more parameters that indicate a presence of a DMRS symbol in the respective portions of resources of the set of resources, and where the signaling includes at least one of a DCI scheduling a PDSCH, a DCI scheduling a PUSCH, an SPS PDSCH trigger, a CG PUSCH trigger, a PDCCH configuration message, or a PUCCH configuration message.

In some implementations of the NE, the processor, and the method described herein, the NE, the processor, and the method may further be configured to, capable of, or operable to receive, prior to transmitting the signaling, additional signaling that indicates one or more parameters, where the one or more density values are based on the one or more parameters. In some implementations of the NE, the processor, and the method described herein, the additional signaling includes a CSI report, and where the one or more parameters include at least one of a channel flatness factor or a channel coherence period across at least one of a time domain and a frequency domain. In some implementations of the NE, the processor, and the method described herein, a density value of the one or more density values corresponds to a partitioning of the set of resources into two subsets of resources, and where a first subset of resources of the two subsets of resources includes a first numerical quantity of DMRS symbols per resource, and where a second subset of resources of the two subsets of resources includes a second numerical quantity of DMRS symbols per resource. In some implementations of the NE, the processor, and the method described herein, a ratio of a numerical quantity of resources in the first subset of resources and a total numerical quantity of resources in the set of resources is based on the density value.

In some implementations of the NE, the processor, and the method described herein, the signaling includes a QCL relationship that associates a first set of DMRS symbols in the first subset of resources with a second set of DMRS symbols in the second subset of resources, and where the QCL relationship is with respect to one or more characteristics including at least one of an average delay, a delay spread, a Doppler shift, a Doppler spread, a spatial transmit filter or a spatial receive filter. In some implementations of the NE, the processor, and the method described herein, the first numerical quantity of DMRS symbols per resource associated with the first subset of resources is greater than the second numerical quantity of DMRS symbols per resource associated with the second subset of resources. In some implementations of the NE, the processor, and the method described herein, the second numerical quantity of DMRS symbols per resource is zero. In some implementations of the NE, the processor, and the method described herein, the second subset of resources includes a ZP DMRS, where symbols corresponding to the ZP DMRS in the second subset of resources are associated with DMRS symbols in the first subset of resources via a QCL relationship with respect to one or more characteristics, and where the one or more characteristics include at least one of an average delay, a delay spread, a Doppler shift, a Doppler spread, a spatial transmit filter, or a spatial receive filter.

In some implementations of the NE, the processor, and the method described herein, the NE, the processor, and the method may further be configured to, capable of, or operable to transmit feedback including a NACK corresponding to a received TB, or receive the feedback including a NACK corresponding to a transmitted TB, and receive or transmit one or more additional DMRS symbols based on a default density value associated with the set of ports of the one or more DMRS symbol. In some implementations of the NE, the processor, and the method described herein, the default density value is one. In some implementations of the NE, the processor, and the method described herein, the NE, the processor, and the method may further be configured to, capable of, or operable to apply the default density value to the one or more additional DMRS symbols a time period after the feedback is transmitted or received. In some implementations of the NE, the processor, and the method described herein, the physical channel is a PDSCH, a PDCCH, a PUSCH, or a PUCCH.

### BRIEF DESCRIPTION OF THE DRAWINGS

FIG. 1 illustrates an example of a wireless communications system in accordance with aspects of the present disclosure.

FIG. 2 illustrates a scenario for an aperiodic trigger state defining a list of CSI report settings, in accordance with aspects of the present disclosure.

FIG. 3 illustrates an aperiodic trigger state indicating a resource set and QCL information, in accordance with aspects of the present disclosure.

FIG. 4 illustrates an example of a radio resource control (RRC) configuration for non-ZP-CSI-reference signals (NZP-CSI-RSs), in accordance with aspects of the present disclosure.

FIG. 5 illustrates an example of an RRC configuration for CSI-interference management (CSI-IM) resources, in accordance with aspects of the present disclosure.

FIG. 6 illustrates a scenario for partial CSI omission, in accordance with aspects of the present disclosure.

FIGS. 7 and 8 illustrate examples of information elements (IEs), in accordance with aspects of the present disclosure.

FIGS. 9 and 10 illustrate examples of DMRS configurations for mapping a QCL Type A with front-load DMRS, in accordance with aspects of the present disclosure.

FIG. 11 illustrates an example of a wireless communications system in accordance with aspects of the present disclosure.

FIGS. 12 and 13 illustrate example signaling diagrams in accordance with aspects of the present disclosure.

FIG. 14 illustrates an example of a UE in accordance with aspects of the present disclosure.

FIG. 15 illustrates an example of a processor in accordance with aspects of the present disclosure.

FIG. 16 illustrates an example of an NE in accordance with aspects of the present disclosure.

FIG. 17 illustrates a flowchart of a method performed by a UE in accordance with aspects of the present disclosure.

FIG. 18 illustrates a flowchart of a method performed by an NE in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. For example, devices in the wireless communications system (e.g., the UE and the NE) may support transmitting and/or receiving signals concurrently using multiple antenna ports. An antenna port, also referred to as a port, is a logical transmission or reception point in the wireless communications system that maps logical signal paths and physical antenna elements. A device may perform spatial multiplexing to transmit data by transmitting multiple data streams concurrently over a same data channel (e.g., uplink channel or downlink channel) using multiple respective antenna ports, such that the data streams are spatially diverse over respective spatial layers. The respective spatial layers may experience different channel conditions, and a device receiving the data streams may estimate the channel conditions for the spatial layers to receive and decode the multiplexed data. For example, a transmitting device may transmit one or more reference signals (e.g., DMRSs, among other examples) over the respective spatial layers, and a receiving device may use the reference signals to estimate the channel conditions for the spatial layers. However, the reference signals occupy communication resources (e.g., time-frequency resources, spatial resources) that the transmitting device may otherwise use for a data transmission. Further, as a number of spatial layers increases, the proportion of resources dedicated to reference signals increases, leading to increased signaling overhead related to transmitting the reference signals. The amount the channel conditions vary across the spatial layers may change according to an environment of the transmitting device, among other factors, leading to inefficient use of the communication resources for environments in which the channel conditions across the spatial layers are similar (e.g., within a threshold difference from one another).

As described herein, to reduce signaling overhead related to transmitting reference signals and to improve resource allocation for spatial multiplexing, an NE may configure a UE to dynamically adjust a numerical quantity of reference signals across communication resources, referred to as a density of the reference signals. For example, the NE may transmit signaling to the UE that includes one or more density values for DMRS symbols across resources (e.g., resources in at least one of a time domain, a frequency domain, and/or a spatial domain) in a physical channel. The density values may include, but are not limited to, a frequency density across RBs, a time density across slots, explicit indications of a presence of DMRS symbols in the resources, or any other density value of the DMRS symbols across the resources. In some examples, if the physical channel is an uplink channel (e.g., a PUCCH or a PUSCH), then the UE may transmit the DMRS symbols to the NE according to the density values. In some other examples, if the physical channel is a downlink channel (e.g., a PDCCH or a PDSCH), then the UE may receive the DMRS symbols from the NE according to the density values.

By performing the described techniques, a device in a wireless communications system can dynamically adjust the density of reference signals across resources (e.g., a number of resources occupied by reference signals), which may provide for reduced signaling overhead and more efficient use of resources related to transmitting reference signals. For example, in environments where channel conditions across spatial layers are relatively similar (e.g., within a threshold value), the NE may configure the UE to transmit or receive fewer reference signals. The NE and the UE may adjust a number of reference signals according to the density to account for a channel estimation accuracy and a data transmission capacity.

Reference is made herein to communicating data or information, such as signaling density values and/or reference signals (e.g., DMRSs) that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

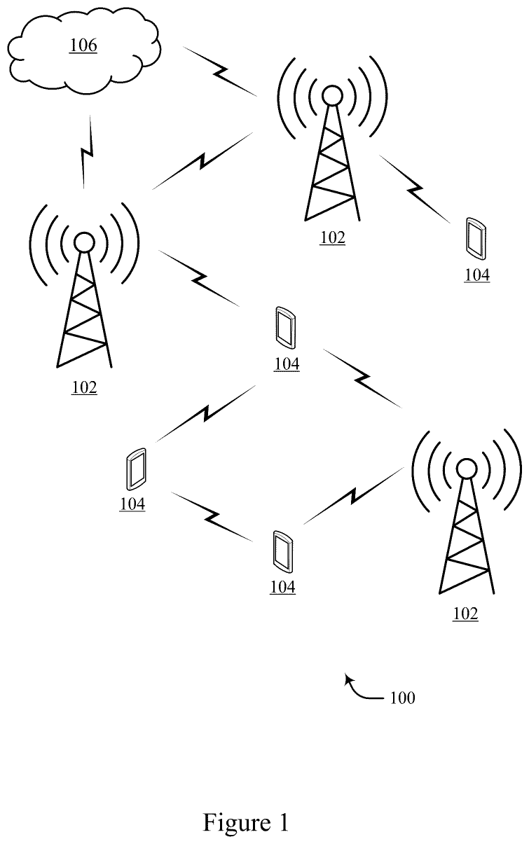

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations frequency range 1 (FR1) (410 MHz-7.125 Gigahertz (GHz)), frequency range 2 (FR2) (24.25 GHz-52.6 GHz), frequency range 3 (FR3) (7.125 GHZ-24.25 GHZ), FR4 (52.6 GHZ-114.25 GHz), frequency range 4a (FR4a) or frequency range 4-1 (FR4-1) (52.6 GHz-71 GHz), and frequency range 5 (FR5) (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Some wireless communications systems may support relatively large bandwidth values for relatively higher data rates (e.g., greater than a threshold bandwidth to satisfy a threshold data rate) by implementing multi-layer signaling. For example, an NE 102 and a UE 104 in the wireless communications system 100 may support multi-layer signaling by transmitting and/or receiving data or control signaling via a physical channel concurrently over multiple layers in the spatial domain using multiple antenna ports. The signaling sent via the different layers may experience different channel conditions. Thus, the NE 102 and/or the UE 104 may transmit reference signals for channel estimation and decoding of signaling sent via respective layers, such that each layer may have a corresponding set of one or more reference signals (e.g., DMRSs). As a number of layers increases, a number of reference signals may also increase, which may lead to increased signaling overhead for channel estimation and decoding (e.g., via multi-port DMRS).

The NE 102 and/or the UE 104 may transmit the reference signals using one or more resources, such as resources in the time domain, frequency domain, and/or spatial domain. In some cases, the NE 102 and/or the UE 104 may include DMRS symbols in all slots and/or RBs carrying data. However, including DMRS symbols in all slots and/or RBs carrying data may be unnecessary, such as for wireless channels with relatively slow (e.g., less than a threshold) variation in time. For example, measurements of the wireless channel may vary less than a threshold amount between layers in one or more environments or communication scenarios, including scenarios in which a UE 104 is a fixed wireless access (FWA) node that is placed in a fixed location. Additionally, or alternatively, in poorly scattered environments, the wireless channel may be flat (e.g., with less than a threshold variation between layers) for a fraction of a bandwidth part (BWP).

In some cases, poorly scattered environments may include environments with few to no (e.g., less than a threshold number of) reflections, diffractions, or scattering of radio waves. In poorly scattered environments, a wireless channel may exhibit less frequency selectivity and temporal variation compared to richly scattered environments, which may lead to a flatter frequency response across the channel bandwidth and slower changes in channel conditions over time. Thus, UEs 104 and/or NEs 102 in poorly scattered environments may be able to use fewer reference signals for accurate channel estimation, as the channel conditions may remain relatively stable across frequency and time domains. However, the UEs 104 and/or NEs 102 may be configured to transmit reference signals (e.g., DMRSs) in all slots and/or RBs carrying data regardless of an environment or communication scenario of the UEs 104 and the NEs 102, resulting in inefficient use of communication resources and increased signaling overhead in one or more environments or communication scenarios (e.g., in the poorly scattered environments, among other examples).

According to implementations, one or more of the NEs 102 and the UEs 104 are operable to implement various aspects of the techniques described with reference to the present disclosure. For example, a UE 104 receives signaling from an NE 102 that indicates one or more density values for reference signals in multi-layer signaling. The density values may indicate a numerical quantity of reference signal symbols (e.g., DMRS symbols) that the UE 104 or the NE 102 is to include across resources. The UE 104 and/or the NE 102 may transmit the reference signal symbols according to the density values. Thus, the NE 102 may dynamically scale a reference signal density across resources (e.g., RBs in the frequency domain and/or slots in the time domain, among other example resources). In some cases, the NE 102 may obtain one or more reference signal measurements (e.g., by measuring reference signals received from a UE 104 or in a report from the UE 104). The reference signal measurements may include, but are not limited to, a CSI-RS measurement, a sounding reference signal (SRS) measurement, and/or any other reference signal measurement. The NE 102 may use the reference signal measurements to determine the density values for one or more DMRS symbols across resources (e.g., time slots and frequency RBs). Additionally, or alternatively, the NE 102 may schedule a multi-layer uplink or downlink transmission with a single DCI and a common set of DMRS ports across one or more slots. Additionally, or alternatively, the NE 102 and/or the UE 104 may transmit ZP DMRSs in slots and/or RBs that include data (e.g., a PDSCH and/or a PUSCH) rather than actual DMRS symbols, where a QCL relationship is established for the ZP DMRS with a corresponding DMRS in a previous transmission or reception occasion.

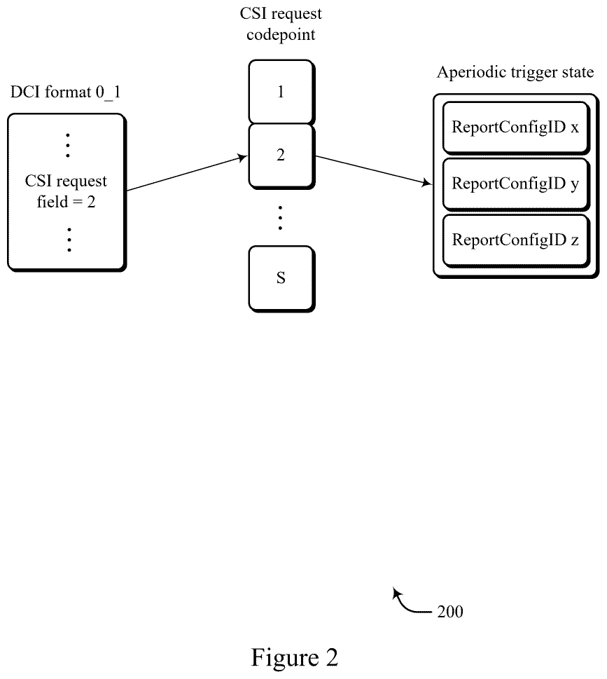

In some examples, the UE 104 may transmit one or more reference signal measurements to the NE 102 in a report, and the NE 102 may use the reference signal measurements to determine the density values for one or more DMRS symbols. The report may be a CSI report, which is described in further detail with respect to FIGS. 2 through 6.

In some cases, the CSI report may include CSI according to a structure, where the structure may be referred to as a codebook or codebook report. For example, the CSI report may use a predefined set of codewords that are part of a codebook to represent one or more channel conditions. The codebook may include a finite set of precoding matrices or vectors that can be used to describe precoding for a downlink transmission. When generating a codebook report, a UE 104 may evaluate one or more channel conditions (e.g., reference signal measurements) and select one or more codewords from the codebook that best represent the current channel state. The report may include information, such as a precoding matrix indicator (PMI), a rank indicator (RI), and/or a channel quality indicator (CQI). The UE 104 may transmit the codebook report to the NE 102 in CSI reporting, and the NE 102 can then use the codebook report to determine one or more downlink transmission parameters, such as a modulation and coding scheme (MCS) and the density values for the DMRS symbols, among other examples.

For CSI reporting a codebook report may be partitioned into two parts based on a priority of information reported. A UE 104 may encode a first part (e.g., Part 1) and a second part (e.g., Part 2) of the codebook separately (e.g., where Part 1 may have a higher code rate). For a CSI report that includes a Type-II codebook, a Part 1 may include a RI, a CQI, and a total number of coefficients, while a Part 2 may include a spatial domain basis indicator, a frequency domain basis indicator or layer, a Bitmap or layer, a coefficient amplitude information or layer, a coefficient phase information or layer, and a strongest coefficient indicator or layer. Additionally, or alternatively, Part 2 of the CSI report may be decomposed into sub-parts, each with different priority (e.g., higher priority information listed first). Such partitioning can be performed to provide for dynamic reporting size for a codebook based on available resources in an uplink phase. Additionally, or alternatively, a Type-II codebook may be based on aperiodic CSI reporting and reported in a PUSCH via a DCI triggering. A Type-I codebook may be based on periodic CSI reporting (e.g., PUCCH) or semi-persistent CSI reporting (e.g., PUSCH or PUCCH) or aperiodic reporting (e.g., PUSCH).

For triggering aperiodic CSI reporting on a PUSCH, a UE 104 may report CSI information to the NE 102 using a defined CSI framework. The triggering mechanism between a report setting and a resource setting is summarized in Table 1 below.

TABLE 1

| | | | | Access |
|---|---|---|---|---|
| | | | Semi-Persistent | Point |
| | | Periodic CSI | (SP) CSI | (AP) CSI |
| | | reporting | reporting | Reporting |
| Time domain | Periodic CSI-RS | RRC configured | medium access | DCI |
| behavior of | | | control (MAC) | |
| resource setting | | | control element | |
| | | | (CE) (PUCCH) | |
| | | | DCI (PUSCH) | |
| | SP CSI-RS | Not Supported | MAC CE | DCI |
| | | | (PUCCH) | |
| | | | DCI (PUSCH) | |
| | AP CSI-RS | Not Supported | Not Supported | DCI |

Additionally, or alternatively, associated resource settings for a CSI report setting may have a same time domain behavior. Periodic CSI-RS and/or interference management (IM) resource and CSI reports may be present and active once configured by RRC signaling. Aperiodic and semi-persistent CSI-RS and/or IM resources and CSI reports may be explicitly triggered or activated. For aperiodic CSI-RS and/or IM resources and aperiodic CSI reports, triggering can be done jointly by transmitting a DCI with a Format 0_1, which is described in further detail with respect to FIG. 2. Semi-persistent CSI-RS and/or IM resources and semi-persistent CSI reports can be independently activated.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

FIG. 2 illustrates a scenario 200 for an aperiodic trigger state defining a list of CSI report settings, in accordance with aspects of the present disclosure. In some examples, the scenario 200 implements or is implemented by aspects of the wireless communications system 100. For example, the scenario 200 may be implemented by a UE, which may be an example of a UE 104 as described with reference to FIG. 1.

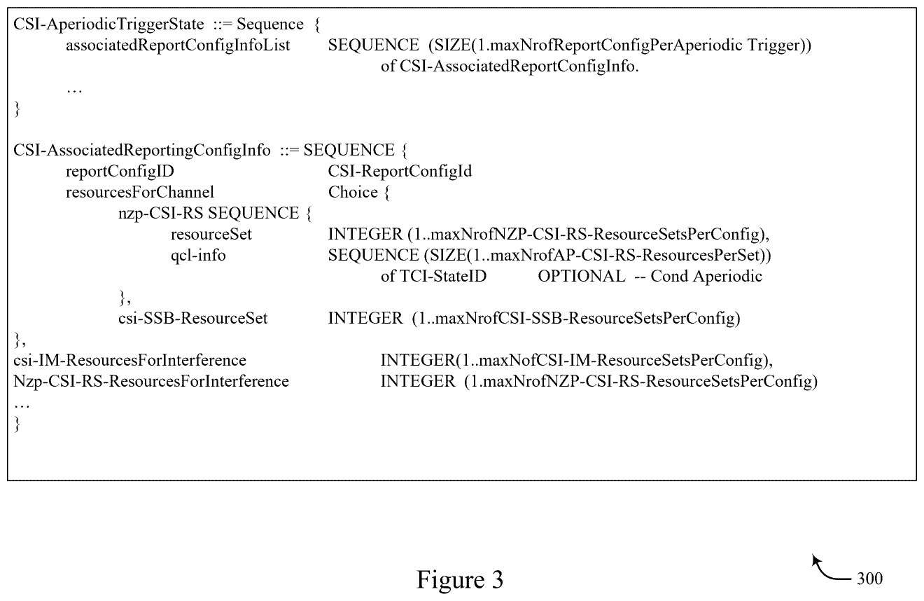

For aperiodic CSI-RS and/or IM resources and aperiodic CSI reports, an NE may trigger a CSI report jointly by transmitting a DCI Format 0_1. The DCI Format 0_1 may include a CSI request field (e.g., 0 to 6 bits). A non-zero CSI request field can point to an aperiodic trigger state configured by RRC signaling. An aperiodic trigger state can be defined as a list of up to 16 aperiodic CSI report settings, identified by a CSI report setting ID (e.g., a ReportConfigID parameter) for which the UE calculates CSI and transmits the CSI on a scheduled PUSCH transmission, which is shown in further detail with respect to FIG. 3.

If a CSI report setting is linked with an aperiodic resource setting (e.g., including multiple resource sets), then the aperiodic trigger state definition may include an aperiodic NZP CSI-RS resource set for channel measurement, an aperiodic CSI-IM resource set, and/or an aperiodic NZP CSI-RS resource set for an IM to use for a given CSI report setting. For aperiodic NZP CSI-RS, a QCL source to use can also be configured in the aperiodic trigger state. A UE can determine that the resources used for the computation of the channel and interference can be processed with a same spatial filter (e.g., QCLed with respect to a QCL type, including QCL-TypeD).

FIG. 3 illustrates an aperiodic trigger state 300 indicating a resource set and QCL information, in accordance with aspects of the present disclosure. In some examples, the aperiodic trigger state 300 implements or is implemented by aspects of the wireless communications system 100 and the scenario 200. For example, the aperiodic trigger state 300 may be sent from an NE to a UE, which may be an example of an NE 102 and a UE 104 as described with reference to FIG. 1. The aperiodic trigger state 300, for example, can be utilized for configuring CSI reported by UE. A UE may use the aperiodic trigger state 300 to generate and transmit CSI reports based on the described CSI framework.

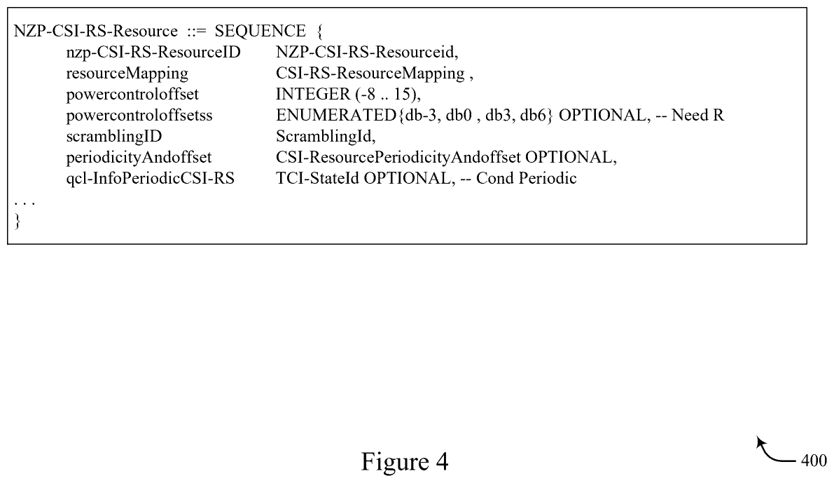

FIG. 4 illustrates an example of an RRC configuration 400 for NZP-CSI-RSs, in accordance with aspects of the present disclosure. In some examples, the RRC configuration 400 implements or is implemented by aspects of the wireless communications system 100, the scenario 200, and the aperiodic trigger state 300. For example, the RRC configuration 400 may be sent from an NE to a UE, which may be an example of an NE 102 and a UE 104 as described with reference to FIG. 1. In some examples, the RRC configuration 400 can be used by a UE to identify NZP-CSI-RS resources, such as NZP-CSI-RS resources that correspond to one or more beams that a UE uses to receive signaling. The UE may measure the signaling to determine whether near field events occur.

In some examples, a near-field event may occur when a UE is in a relatively close proximity to (e.g., within a threshold distance from) a transmitting antenna. To determine whether near-field events are occurring, a UE may measure signaling sent using one or more beams and may analyze various characteristics of the received signals. The UE may evaluate a received signal strength, phase, and angle of arrival (AoA) across different frequency subcarriers or antenna elements. By comparing the measurements to expected far-field behavior, the UE may detect deviations that indicate near-field events. For example, the UE may detect frequency variations in an AoA or unexpected differences in channel responses across the antenna array. Additionally, or alternatively, the UE may analyze a spatial correlation of received signals across multiple antenna elements to detect non-stationary behavior characteristic of near-field propagation.

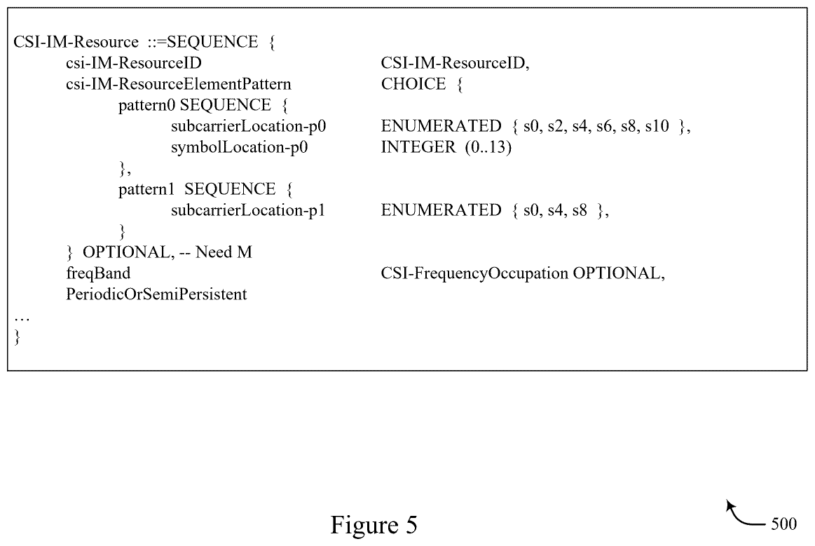

FIG. 5 illustrates an example of an RRC configuration 500 for CSI-IM resources, in accordance with aspects of the present disclosure. In some examples, the RRC configuration 500 implements or is implemented by aspects of the wireless communications system 100, the scenario 200, the aperiodic trigger state 300, and the RRC configuration 400. For example, the RRC configuration 500 may be sent from an NE to a UE, which may be an example of an NE 102 and a UE 104 as described with reference to FIG. 1. The RRC configuration 500 can be used to identify IM resources, such as for identifying and managing signal interference between an NE and a UE.

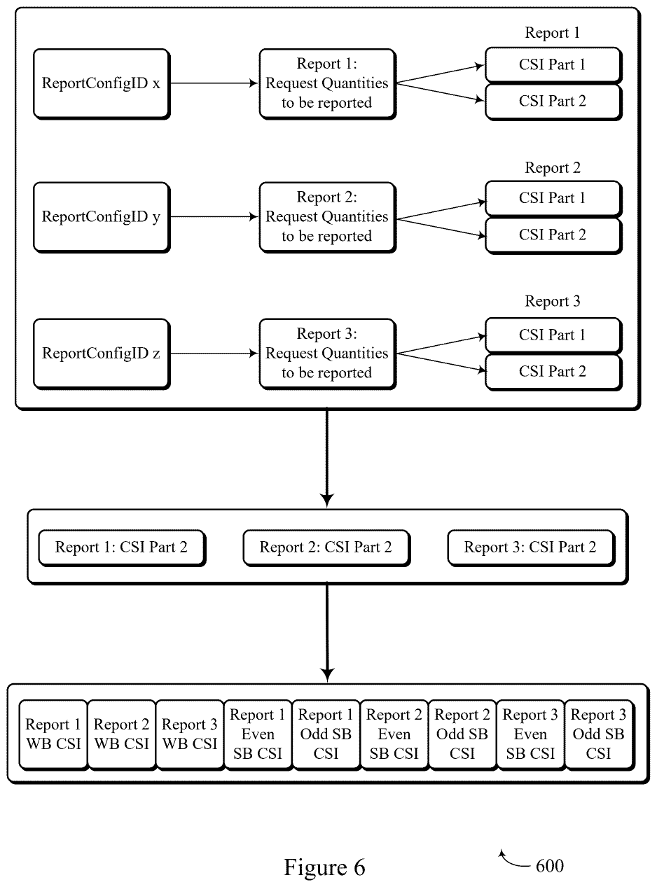

FIG. 6 illustrates a scenario 600 for partial CSI omission, in accordance with aspects of the present disclosure. In some examples, the scenario 600 implements or is implemented by aspects of the wireless communications system 100, the scenario 200, the aperiodic trigger state 300, the RRC configuration 400, and the RRC configuration 500. For example, the scenario 600 may be implemented by an NE and/or a UE, which may be an example of an NE 102 and a UE 104 as described with reference to FIG. 1. The scenario 600, for example, illustrates a packing order of CSI parts within the CSI report to be transmitted within uplink control information (UCI). The CSI measured from one or more reference signals is mapped to one or more CSI reports, where the packing of the CSI is as illustrated in the scenario 600.

In some examples, for aperiodic CSI reporting, PUSCH-based reports can be divided into two CSI parts, including a CSI Part1 and a CSI Part 2. The size of CSI payloads can vary, and therefore an UCI payload size design may result in relatively large signaling overhead (e.g., greater than a threshold value). In some cases, CSI Part 1 has a fixed payload size (e.g., and can be decoded by an NE without prior information) and includes one or more parameters. For example, the CSI Part 1 may include but is not limited to, a RI (e.g., if reported), a CSI-RS resource index (CRI)) (e.g., if reported), a CQI for a first codeword, and/or a number of non-zero wideband amplitude coefficients per layer for Type II CSI feedback on a PUSCH.

In some cases, CSI Part 2 has a variable payload size that can be derived from one or more CSI parameters in the CSI Part 1 and can include PMI and the CQI for the second codeword (e.g., if RI>4). For example, if the aperiodic trigger state indicated by DCI format 0_1 defines 3 report settings (e.g., according to a ReportConfigIDs parameter) x, y, and z, then an aperiodic CSI reporting for CSI Part 2 can be ordered as indicated in the scenario 600. The scenario 600 includes reports for wide-band (e.g., WB CSI) and sub-band (e.g., SB CSI).

One or more CSI reports can be prioritized according to time-domain behavior and physical channel, where more dynamic reports are given precedence over less dynamic reports and PUSCH has precedence over PUCCH. Additionally, or alternatively, the CSI reports can be prioritized according to CSI content, where beam reports (e.g., layer 1-reference signal receive power (L1-RSRP) reporting) may have priority over regular CSI reports. Additionally, or alternatively, the CSI reports can be prioritized according to the serving cell to which the CSI corresponds (e.g., in case of carrier aggregation (CA) operation), where a CSI corresponding to a primary cell (PCell) may have priority over a CSI corresponding to one or more secondary cells (Scells). Additionally, or alternatively, the CSI reports can be prioritized according to the reportConfigID parameter.

In some examples, a UE and/or an NE may support codebook subset restriction (CBSR) for Type-I and Type-II CSI for controlling inter-cell interference levels. In Type-I CBSR, a size N₁N₂O₁O₂ bitmap is used to indicate a restricted beam, where N₁/N₂ and O₁/O₂ indicate a number of horizontal or vertical ports and horizontal or vertical oversampling factors, respectively. Each bit in the sequence restricts a Discrete Fourier Transform (DFT) beam for an oversampling index.

The bitmap parameter typeI-SinglePanel-codebookSubsetRestriction-i2 forms a bit sequence b₁₅, . . . , b₁, b₀, where b₀ is a least significant bit (LSB) and b₁₅ is a most significant bit (MSB). The bit bᵢ is associated with precoders corresponding to codebook index i₂=i. When bᵢ is zero, the randomly selected precoder for CQI calculation may not correspond to a precoder associated with the bit bᵢ.

In Type-II CBSR, instead of a hard restriction decision (e.g., a DFT beam within an oversampling index is either fully prohibited or unrestrictedly available), an amplitude restriction may be imposed. For example, N₁N₂O₁O₂ candidate DFT beams are regrouped into O₁O₂ beam groups (e.g., beams within a beam group may not belong to the same oversampling index). Beam restriction is allowed on 4 out of the O₁O₂ beam groups

$$( e . g . , ⌈ {log}_{2} {C}_{4}^{{O}_{1} {O}_{2}} ⌉$$

bits are used to indicate the restricted beam groups). For the 4N₁N₂ restricted beams across the 4 beam groups, 2 bits are allocated per beam to indicate the restriction on the maximum allowed amplitude value from a coebook of amplitude value restrictions, where the amplitude restriction,

$$Amp . = \{ 1 , {( \frac{1}{2} )}^{\frac{1}{2}} , {( \frac{1}{4} )}^{\frac{1}{2}} , 0 \}$$

(e.g., −3 dB step size per restriction value in power domain). Thus, 8N₁N₂ bits can be used to report the amplitude restrictions for the 4 restricted beam groups based on Type-II soft restriction.

The bitmap parameter n1-n2-codebookSubsetRestriction-r16 forms a bit sequence B=B₁B₂ and configures the vector group indices g^{(k)}.

$$Bits {b}_{2}^{( k , 2 ( {N}_{1} {x}_{2} + {x}_{1} ) + 1 )} {b}_{2}^{( k , 2 ( {N}_{1} {x}_{2} + {x}_{1} ) )}$$

indicate a maximum allowed average amplitude, γ_{i+pL} (μ=0,1), with i∈{0, 1, . . . , L−1} corresponding to a beam index, of the coefficients associated with the vector in group g^{(k)} indexed by x₁, x₂, where the maximum amplitudes are given in Table 2 and the average coefficient amplitude is restricted according to Equation 1:

$$\sqrt{\frac{1}{{\sum }_{f = 0}^{{M}_{v} - 1} {k}_{l , i + pL , f}^{( 3 )}} {\sum }_{f = 0}^{{M}_{v} - 1} {{k}_{l , i + pL , f}^{( 3 )} ( {p}_{l , p}^{( 1 )} {p}_{l , i + pL , f}^{( 2 )} )}^{2}} \leq {γ}_{i + pL} \qquad ( 1 )$$

for l=1, . . . , υ, is a layer index, f∈{0, 1, . . . , Mᵥ−1} is a frequency-domain basis index, and p=0,1 is a polarization index. A UE that does not report the parameter softAmpRestriction-r16=‘supported’ in its capability signaling is not expected to be configured with

$${b}_{2}^{( k , 2 ( {N}_{1} {x}_{2} + {x}_{1} ) + 1 )} {b}_{2}^{( k , 2 ( {N}_{1} {x}_{2} + {x}_{1} ) )} = 01 or 10.$$

TABLE 2

| | Maximum |
|---|---|
| | average |
| | coefficient |
| $Bit {b}_{2}^{( k , 2 ( {N}_{1} {x}_{2} + {x}_{1} ) + 1} {b}_{2}^{( k , 2 ( {N}_{1} {x}_{2} + {x}_{1} ) )}$ | amplitude γ_{i+pL} |
| 00 | 0 |
| 01 | \sqrt{1/4} |
| 10 | \sqrt{1/2} |
| 11 | 1 |

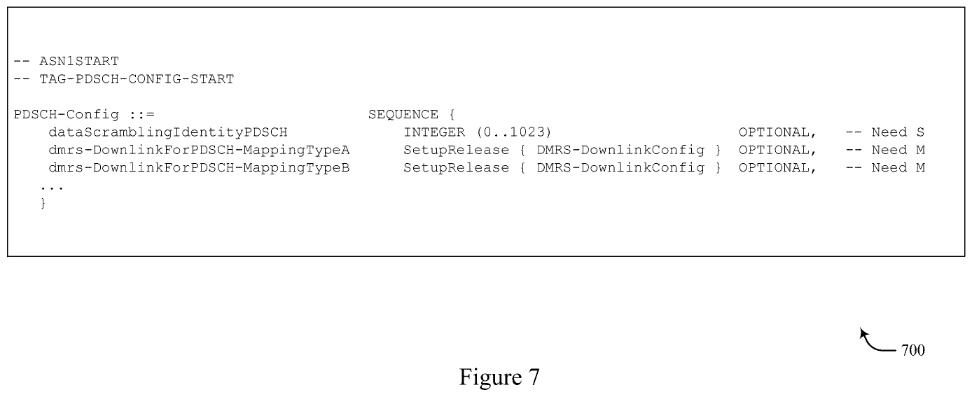

FIG. 7 illustrate an example of an IE 700, in accordance with aspects of the present disclosure. In some examples, the IE 700 implements or is implemented by aspects of the wireless communications system 100, the scenario 200, the aperiodic trigger state 300, the RRC configuration 400, the RRC configuration 500, and the scenario 600. For example, the IE 700 may be sent from an NE to a UE, which may be an example of an NE 102 and a UE 104 as described with reference to FIG. 1. The IE 700 may represent an abstract syntax notation (ASN)-1 code for a PDSCH-Config IE.

For a reception of DMRSs for PDSCH, QCL Type A properties (e.g., Doppler shift, Doppler spread, average delay, delay spread) can be inferred from a periodic tracking reference signal (TRS). For periodic TRSs, QCL Type C properties (e.g., average delay, Doppler shift) can be inferred from a synchronization signal block (SSB). A DMRS is used to estimate channel coefficients for coherent detection of one or more physical channels. For a downlink direction, the DMRS is subject to a same precoding as a PDSCH. In some cases, NR defines two time-domain structures for DMRS according to a location of a first DMRS symbol. For example, for a mapping Type A time-domain structure, the first DMRS is located in the second and the third symbol of the slot, and the DMRS is mapped relative to the start of the slot boundary, regardless of where in the slot the actual data transmission occurs. Additionally, or alternatively, for a mapping Type B time-domain structure, the first DMRS is positioned in the first symbol of the data allocation. That is, the DMRS location is not given relative to the slot boundary, rather relative to where the data are located.

The mapping of PDSCH transmission can be dynamically signaled as part of DCI. In some cases, the DMRS has two types, Type 1 and Type 2, which are distinguished in a frequency domain mapping and a maximum number of orthogonal reference signals. Type 1 can provide up to four orthogonal signals using a single-symbol DMRS and up to eight orthogonal reference signals using a double-symbol DMRS. For four orthogonal signals, ports with identifiers 1000 and 1001 use even-numbered subcarriers and are separated in the code domain within the code-division multiplexing (CDM) group (e.g., length-2 orthogonal sequences in the frequency domain). Antenna ports 1000 and 1001 belong to CDM group 0, as they use the same subcarriers. Additionally, or alternatively, ports with identifiers 1002 and 1003 belong to a CDM group 1 and are generated in a similar manner using odd-numbered subcarriers. A DMRS Type 2 has a similar structure to Type 1, but Type 2 can provide 6 and 12 patterns depending on the number of symbols. Four subcarriers are used in each RB and in each CDM group defining three CDM groups.

In the IE 700, a configuration of the a DMRS type is provided through higher layer signaling independently for each PDSCH and PUSCH, each mapping a DMR type (e.g., Type A or Type B), and each BWP independently. A NE may use a PDSCH-Config IE (e.g., the IE 700) to configure a UE with one or more PDSCH parameters.

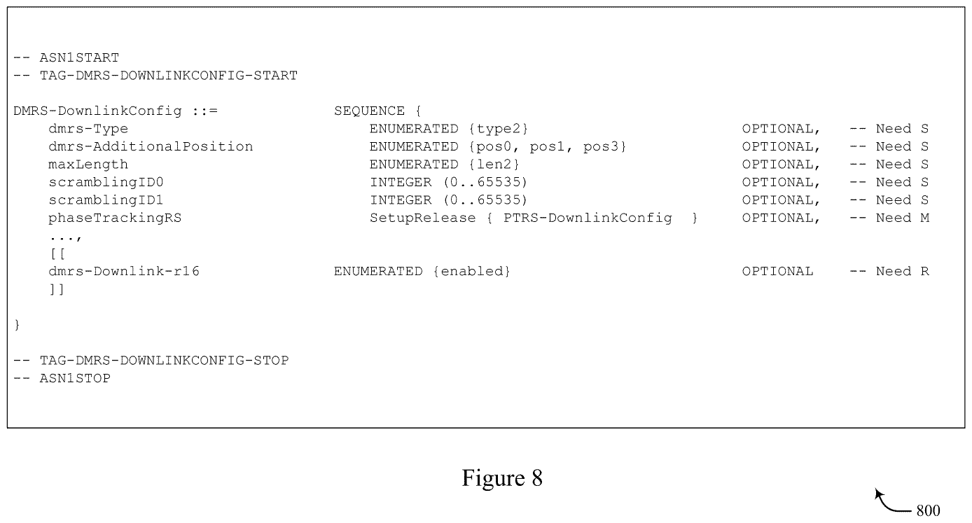

FIG. 8 illustrates an example IE 800, in accordance with aspects of the present disclosure. In some examples, the IE 800 implements or is implemented by aspects of the wireless communications system 100, the scenario 200, the aperiodic trigger state 300, the RRC configuration 400, the RRC configuration 500, the scenario 600, and the IE 700. For example, the IE 800 may be sent from an NE to a UE, which may be an example of an NE 102 and a UE 104 as described with reference to FIG. 1. The IE 800, for example, includes ASN-1 code for an IE configuration, DMRS-DownlinkConfig. 1n the IE 800, the IE DMRS-DownlinkConfig can be used to configure downlink demodulation reference signals for PDSCH.

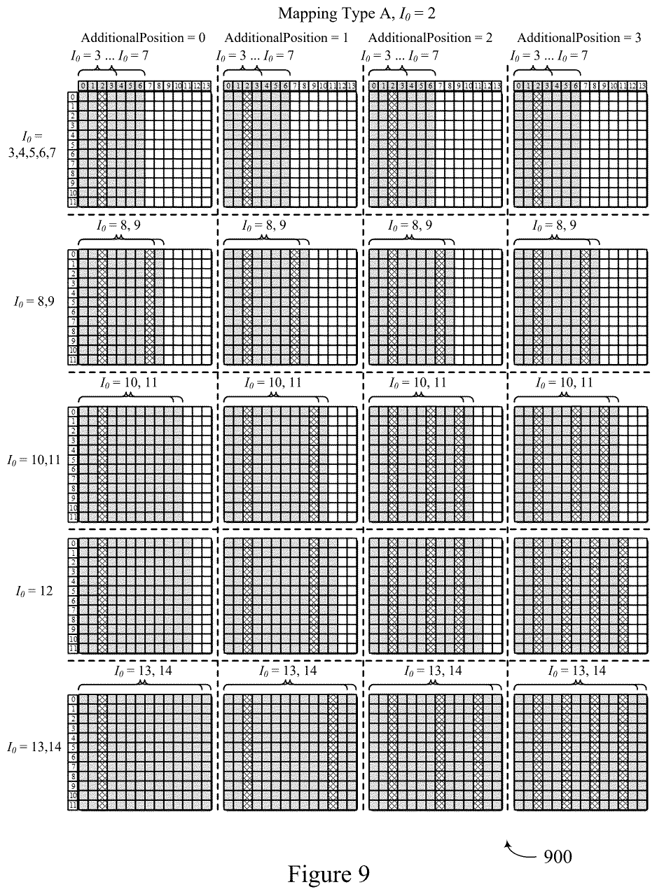

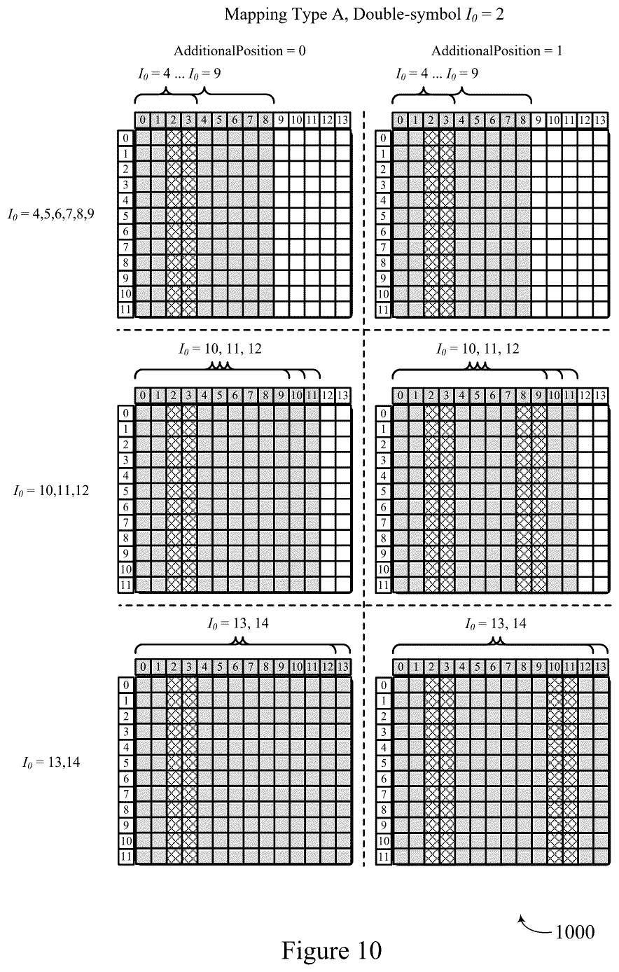

FIG. 9 illustrate an example of a DMRS configuration 900 for mapping a QCL Type A with front-load DMRS, in accordance with aspects of the present disclosure. In some examples, the DMRS configuration 900 implements or is implemented by aspects of the wireless communications system 100, the scenario 200, the aperiodic trigger state 300, the RRC configuration 400, the RRC configuration 500, the scenario 600, the IE 700, and the IE 800. For example, the DMRS configuration 900 may be sent from an NE to a UE, which may be an example of an NE 102 and a UE 104 as described with reference to FIG. 1. In some cases, a DMRS may be associated with a downlink data signal (e.g., DMRS for a PDSCH), an uplink data signal (e.g., DMRS for a PUSCH), or a downlink control signal (e.g., DMRS for a PDCCH). A DMRS for a PDSCH may be mutually QCLed with multiple reference signals associated with the multiple antenna subarrays of an antenna array at an NE, which is described in further detail with respect to FIG. 10.

FIG. 10 illustrate an example of a DMRS configuration 1000 for mapping a QCL Type A with front-load DMRS, in accordance with aspects of the present disclosure. In some examples, the DMRS configuration 1000 implements or is implemented by aspects of the wireless communications system 100, the scenario 200, the aperiodic trigger state 300, the RRC configuration 400, the RRC configuration 500, the scenario 600, the IE 700, the IE 800, and the DMRS configuration 900. For example, the DMRS configuration 1000 may be sent from an NE to a UE, which may be an example of an NE 102 and a UE 104 as described with reference to FIG. 1.

In the DMRS configuration 1000, a time domain mapping of DMRS patterns can be decomposed (e.g., split, partitioned) into two parts. For example, the first part defines a DMRS pattern used for a front loaded DMRS, and then a second part defines a set of additional DMRS symbols inside a scheduled data channel duration. The set of additional DMRS symbols may be either single-symbols or double-symbols based on a length of the front-load DMRS. A front loaded DMRS may refer to a configuration in which DMRSs are concentrated at a beginning of a transmission time interval or slot. Thus, a larger portion of DMRS symbols may be placed in one or more initial symbols of a transmission, rather than being distributed evenly throughout the time-frequency resources. Front loading DMRSs may provide earlier channel estimation, which enables faster decoding of data symbols. Inside the scheduled time-domain allocation of a PDSCH, the UE may expect up to 4 DMRS symbols. The location of the DMRS is defined by both a higher layer configuration and dynamic (e.g., DCI-based) signaling, such as by a dmrs-TypeA-Position parameter in signaling, a maxLength parameter in signaling, and/or a dmrs-AdditionalPosition parameter in signaling. If double-symbol DMRSs are used, then there can be up to one more double-symbol DMRS (e.g., a total of 4 DMRS symbols inside a PDSCH allocation). Different DMRS patterns for mapping Type A with front-loaded DMRS are shown in the DMRS configuration 900 in FIG. 9 and the DMRS configuration 1000 in FIG. 10.

In the absence of a CSI-RS configuration, and unless otherwise configured, a UE may assume a PDSCH DMRS and synchronization signal (SS) or physical broadcast channel (PBCH) block antenna ports are QCLed with respect to Doppler shift, Doppler spread, average delay, delay spread, and spatial receive parameters (e.g., if applicable). However, a CSI-RS for tracking can be used as a QCL reference (e.g., having larger bandwidth than an SS and/or PBCH block). Additionally, or alternatively, the UE may assume that a PDSCH DMRS within a same CDM group are QCLed with respect to Doppler shift, Doppler spread, average delay, delay spread, and spatial receive parameters. The UE may then perform a joint estimation of DMRS ports which are CDMed using same long-term statistics, the UE may not measure, or use, different long-term statistics for different DMRS ports of a same PDSCH.

In some cases, the terms antenna, panel, and antenna panel are used interchangeably. An antenna panel may be a hardware that is used for transmitting and/or receiving radio signals at frequencies lower than 6 GHz (e.g., FR1), or higher than 6 GHz (e.g., FR2) or millimeter wave (mmWave). In some examples, an antenna panel may include an array of antenna elements, where each antenna element is connected to hardware such as a phase shifter that allows a control module to apply spatial parameters for transmission and/or reception of signals. The resulting radiation pattern may be called a beam, which may or may not be unimodal and may provide for a device to amplify signals that are transmitted or received from spatial directions.

In some cases, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, etc., may or may not be transparent to other devices. In some examples, capability information may be communicated via signaling or, in some implementations, capability information may be provided to devices without signaling. In the case that such information is available to other devices, the information can be used for signaling or local decision making.

In some implementations, a device (e.g., UE, node) antenna panel may be a physical or logical antenna array including a set of antenna elements or antenna ports that share a common or a significant portion of an RF chain (e.g., in-phase/quadrature (I/Q) modulator, analog to digital (A/D) converter, local oscillator, phase shift network). The device antenna panel or “device panel” may be a logical entity with physical device antennas mapped to the logical entity. The mapping of physical device antennas to the logical entity may be up to device implementation. Communicating (e.g., receiving or transmitting) on at least a subset of antenna elements or antenna ports active for radiating energy (e.g., also referred to herein as active elements) of an antenna panel involves biasing or powering on of the RF chain which results in current drain or power consumption in the device associated with the antenna panel (e.g., including power amplifier/low noise amplifier (LNA) power consumption associated with the antenna elements or antenna ports).

The phrase “active for radiating energy,” as used herein, is not meant to be limited to a transmit function but also encompasses a receive function. Accordingly, an antenna element that is active for radiating energy may be coupled to a transmitter to transmit RF energy or to a receiver to receive RF energy, either simultaneously or sequentially, or may be coupled to a transceiver in general, for performing its intended functionality. Communicating on the active elements of an antenna panel enables generation of radiation patterns or beams.

In some cases, depending on implementation of a device, a “device panel” can have at least one of the following functionalities as an operational role of unit of antenna group to control its transmit beam independently, unit of antenna group to control its transmission power independently, unit of antenna group to control its transmission timing independently. The “device panel” may be transparent to an NE. For one or more conditions, a gNB or NE can assume a mapping between physical antennas of a device to a logical entity “device panel” may not be changed. For example, the condition may include until the next update or report from device or include a duration of time over which the NE assumes there will be no change to the mapping. A device may report a capability with respect to the “device panel” to the gNB or NE. The device capability may include at least the number of “device panels.” In some examples, the device may support uplink transmission from one beam within a panel. With multiple panels, more than one beam (one beam per panel) may be used for uplink transmission. In another implementation, more than one beam per panel may be supported/used for uplink transmission. In some cases, an antenna port is defined such that the channel over which a symbol on the antenna port is conveyed can be inferred from the channel over which another symbol on the same antenna port is conveyed.

Two antenna ports are QCLed if large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial receive parameters. Two antenna ports may be QCLed with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the UE can assume about their channel statistics or QCL properties. For example, QCL-Type may take at least one of a QCL-TypeA value with Doppler shift, Doppler spread, average delay, and a delay spread, a QCL-TypeB value with a Doppler shift and a Doppler spread, a QCL-TypeC value with a Doppler shift and an average delay, and a QCL-TypeD value with a spatial receive parameter.

Spatial receive parameters may include one or more of AoA, dominant AoA, average AoA, angular spread, power angular spectrum (PAS) of AoA, average angle of departure (AoD), PAS of AoD, transmit and/or receive channel correlation, transmit and/or receive beamforming, or spatial channel correlation, among other examples. QCL-TypeA, QCL-TypeB and QCL-TypeC may be applicable for all carrier frequencies, but the QCL-TypeD may be applicable in higher carrier frequencies (e.g., mmWave, FR2 and beyond), where the UE may not be able to perform omni-directional transmission (e.g. the UE may form beams for directional transmission). For a QCL-TypeD between two reference signals A and B, the reference signal A is considered spatially co-located with reference signal B, and the UE may assume that the reference signals A and B can be received with the same spatial filter (e.g., with the same receiver beamforming weights).

An “antenna port” according to an implementation may be a logical port that may correspond to a beam (resulting from beamforming) or may correspond to a physical antenna on a device. In some examples, a physical antenna may map directly to a single antenna port, in which an antenna port corresponds to an actual physical antenna. Additionally, or alternatively, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the implementations described, a transmission configuration indication (TCI) state associated with a target transmission can indicate parameters for configuring a QCL relationship between the target transmission (e.g., target reference signal of DMRS ports of the target transmission during a transmission occasion) and one or more source reference signals (e.g., SSB, CSI-RS, SRS) with respect to one or more QCL type parameters indicated in the corresponding TCI state. The TCI describes which reference signals are used as QCL source, and what QCL properties can be derived from each reference signal. A device can receive a configuration of a set of transmission configuration indicator states for a serving cell for transmissions on the serving cell. In some cases, a TCI state includes at least one source reference signal to provide a reference (e.g., UE assumption) for determining a QCL and/or a spatial filter.

In some examples, a spatial relation information associated with a target transmission can indicate parameters for configuring a spatial setting between the target transmission and a reference signal (e.g., SSB, CSI-RS, SRS). For example, the device may transmit the target transmission with the same spatial domain filter used for reception the reference signal (e.g., downlink reference signal, such as SSB or CSI-RS). In some other examples, the device may transmit the target transmission with the same spatial domain transmission filter used for the transmission of the reference signal (e.g., uplink reference signal, such as SRS). A device can receive a configuration of a set of spatial relation information configurations for a serving cell for transmissions on the serving cell.

In some of the implementations described, an uplink TCI state is provided if a device is configured with separate downlink or uplink TCI by RRC signaling. The uplink TCI state may include a source reference signal which provides a reference for determining uplink spatial domain transmission filter for the uplink transmission (e.g., dynamic-grant, configured-grant based PUSCH, dedicated PUCCH resources) in a CC or across a set of configured CCs or BWPs.

In some cases, a joint downlink/uplink TCI state is provided if the device is configured with joint downlink/uplink TCI by RRC signaling (e.g., configuration of joint TCI or separate DL/UL TCI is based on RRC signaling). The joint downlink/uplink TCI state refers to at least a common source reference signal used for determining both the downlink QCL information and the uplink spatial transmission filter. The source referenced signal determined from the indicated joint downlink/uplink TCI state (e.g., or common TCI state) provides QCL Type-D indication (e.g., for device-dedicated PDCCH or PDSCH) and is used to determine uplink spatial transmission filter (e.g., for UE-dedicated PUSCH or PUCCH) for a CC or across a set of configured CCs or BWPs. In some examples, the uplink spatial transmission filter is derived from the reference signal of downlink QCL Type D in the joint TCI state. The spatial setting of the uplink transmission may be according to the spatial relation with a reference to the source reference signal configured with QCL-Type set to ‘typeD’ in the joint TCI state.

In some examples, the terms network nodes, transmit-receive point (TRP), panel, set of antennas, set of antenna ports, uniform linear array, cell, node, radio head, communication (e.g., signals or channels) associated with a control resource set (CORESET) pool, communication associated with a TCI state from a transmission configuration including at least two TCI states, may be used interchangeably. A TRS corresponds to an NZP CSI-RS resource set with a parameter ‘trs-info’ being configured. A CSI-RS for beam management corresponds to an NZP CSI-RS resource set with a parameter ‘repetition’ being configured. A CSI-RS for CSI corresponds to an NZP CSI-RS resource set with neither parameters ‘trs-info’ nor ‘repetition’ being configured. A matrix implies a sequence of fields of an arbitrary dimension, including an array (e.g., vector) of values, a standard 2D matrix and/or a Q-dimensional matrix (e.g., tensor) where Q≥2 is an integer value. A mapping between a TB and a codeword transmitted in downlink can be based on a one-to-one mapping between the TBs and codewords.

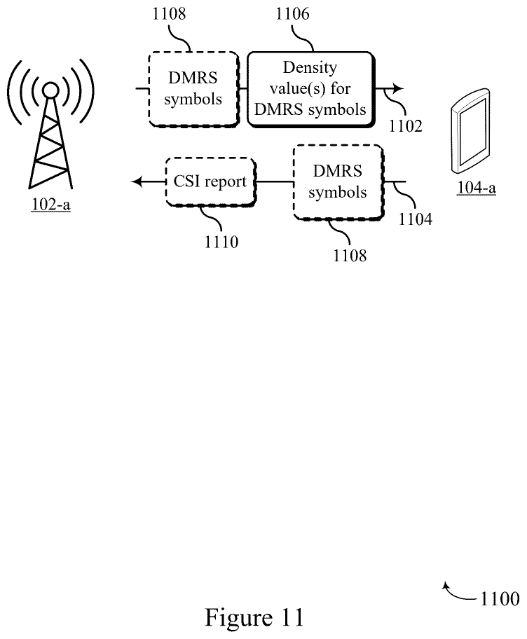

FIG. 11 illustrates an example of a wireless communications system 1100 in accordance with aspects of the present disclosure. In some examples, the wireless communications system 1100 implements or is implemented by aspects of the wireless communications system 100, the scenario 200, the aperiodic trigger state 300, the RRC configuration 400, the RRC configuration 500, the scenario 600, the IE 700, the IE 800, the DMRS configuration 900, and the DMRS configuration 1000. For example, the wireless communications system 1100 may include a UE 104-a and an NE 102-a, which may be examples of an NE 102 and/or a UE 104 as described with reference to FIG. 1.

In some cases, the NE 102-a and the UE 104-a may exchange (e.g., transmit, receive, communicate) signaling. For example, the NE 102-a may transmit signaling to the UE 104-a via a downlink communications link 1102, while the UE 104-a may transmit signaling to the NE 102-a via an uplink communication link 1104. The signaling may be an example of control signaling, including reference signals (e.g., DMRSs), and/or data. For example, the NE 102-a may transmit control signaling that indicates one or more density values for DMRS symbols 1106. The UE 104-a and/or the NE 102-a may use the density values for the DMRS symbols 1106 reported in the control signaling to transmit and/or receive one or more DMRS symbols 1108.

In some examples, the one or more density values for the DMRS symbols 1106 may include a frequency density with a value, a. The frequency density may be no larger than one. The frequency density of value α indicates that the DMRS symbols occupy a fraction

$$( e . g . , α = \frac{1}{2} , \frac{1}{3} , \frac{1}{4} , etc . )$$

of frequency resources (e.g., RBs in a BWP) of a physical channel. Example physical channels may include, but are not limited to, a PDSCH, a PDCCH, a PUSCH, or a PUCCH, among other examples. For example, a frequency density with a value α of ⅓ indicates that DMRS symbols occupy every third RB (RBs with indices 0, 3, 6, 9, 12, etc.). Additionally, or alternatively, a number (e.g., numerical quantity, amount) of DMRS subbands may be a factor of a number of RBs in a BWP, NRB. For example, a number of RBs occupied by a DMRS in a BWP is equal to aNRB.

In some cases, if the UE 104-a and the NE 102-a implement time division duplexing (TDD), then the NE 102-a may infer (e.g., determine, identify, select) a frequency density corresponding to the DMRS symbols for a downlink physical channel (e.g., PDSCH or PDCCH) from a measure of SRS symbols transmitted by the UE. TDD refers to a method of bidirectional communication in the wireless communications system 1100 in which uplink and downlink transmissions share a same frequency band but are separated in time. The NE 102-a may apply a precoding function to a DMRS for a downlink physical channel, such that a channel response is flat over a subset of frequency resources of a BWP, or a receive filter at the UE 104-a is constant for each subband including a DMRS. Additionally, or alternatively, the NE 102-a may determine a frequency density corresponding to the DMRS symbols for an uplink physical channel (e.g., PUSCH or PUCCH) from a measure of SRS symbols transmitted by the UE 104-a. The UE may apply a filter for transmitting the physical uplink channel, such that a channel response is flat over a subset of frequency resources of a BWP, or a receive filter at the NE 102-a is constant for each subband including a DMRS. The NE 102-a may configure a value of a from a set of configured values based on the SRS symbols.

In some examples, the NE 102-a and/or the UE 104-a may apply a similar approach for transmitting DMRS symbols via a physical uplink channel if the NE 102-a and/or the UE 104-a implement frequency division duplexing (FDD). FDD refers to a method of bidirectional communication in the wireless communications system 1100, where uplink and downlink transmissions occur simultaneously on separate frequency bands. For example, if the UE 104-a and the NE 102-a implement FDD with a small duplexing distance (e.g., a distance between an uplink carrier frequency and a downlink carrier frequency is small compared with the uplink carrier frequency, downlink carrier frequency, or a combination thereof), then the NE 102-a applies a first precoding function to one or more CSI-RS symbols transmitted over a BWP. The UE 104-a may measure the one or more CSI-RS symbols received at the UE 104-a and transmit a CSI report 1110 carrying CSI parameters corresponding to a downlink PMI, as well as an indication of a flatness factor based on the received one or more CSI-RS symbols. The NE 102-a may receive the CSI report 1110 from the UE 104-a and may apply a precoding function to one or more DMRSs for a downlink physical channel (e.g., PDSCH or PDCCH) based on the received CSI report 1110. The NE 102-a indicates the frequency density of the DMRS symbols for the downlink physical channel to the UE 104-a in configuration signaling (e.g., a DCI, RRC signaling, a MAC-CE, or any other configuration signaling).

In some other examples, if the UE 104-a and the NE 102-a implement FDD with any duplexing distance, the UE 104-a measures the one or more CSI-RS symbols received at the UE 104-a, and then reports an indication of the flatness factor based on the received one or more CSI-RS symbols across multiple RBs. In some cases, the UE 104-a reports a set of parameters corresponding to an autocorrelation of the channel in the frequency domain or delay domain. The NE 102-a applies a precoding function to one or more DMRSs for a downlink physical channel (e.g., for PDSCH or for PDCCH) based on the received CSI report 1110. The NE 102-a indicates the frequency density of the DMRS symbols for the downlink physical channel to the UE 104-a in configuration signaling.

In some cases, the indication of the flatness factor corresponds to a report quantity associated with a CSI configuration. The UE 104-a may be configured with reporting a channel flatness indicator, which identifies the channel coherence bandwidth per layer (e.g., spatial layer, data stream), or average or worst case across one or more layers. In some examples, the NE 102-a may infer (e.g., determine, identify, select) a value of the flatness factor from a frequency resolution value of a PMI reported by the UE 104-a in the CSI report 1110. The frequency resolution value may correspond to a subband size. In some cases, the UE 104-a may receive one or more DMRSs for a downlink physical channel over alternating RBs. For example, a density of DMRS symbols in the frequency domain may have a value of one half

$$( e . g . , 0.5 , \frac{1}{2} ) ,$$

and the UE 104-a may receive the DMRS symbols over every other RB. That is, the UE 104-a may monitor for and receive DMRS symbols over RBs with even identifier or index values and may not monitor or receive DMRS symbols over RBs with odd identifier or index values. Additionally, or alternatively, the UE 104-a may send one or more DMRSs (e.g., DMRS symbols) over a physical uplink channel (e.g., a PUSCH or PUCCH) using alternating RBs. For example, a density of DMRS symbols in the frequency domain may have a value of one half

$$( e . g . , 0.5 , \frac{1}{2} ) ,$$

and the UE 104-a may transmit the DMRS symbols every other RB. That is, the UE 104-a may transmit the DMRS symbols over RBs with even identifier or index values and may not transmit the DMRS symbols over RBs with odd identifier or index values.

In some examples, the one or more density values for the DMRS symbols 1106 may include a time density with a value, β. The time density of value β indicates that the DMRS symbols occupy a fraction

$$( e . g . , β = \frac{1}{2} , \frac{1}{3} , \frac{1}{4} , etc . )$$

of time resources (e.g., slots) of a physical channel. Example physical channels may include, but are not limited to, a PDSCH, a PDCCH, a PUSCH, or a PUCCH, among other examples. For example, a frequency density with a value β of ¼ indicates that DMRS symbols occupy every fourth slot (slots with indices 0, 4, 8, 12, etc.).

In some cases, if the UE 104-a and the NE 102-a implement TDD, then the NE 102-a may infer (e.g., determine, identify, select) a time density corresponding to DMRSs sent via a downlink physical channel (e.g., for PDSCH or PDCCH) from a measure of SRS symbols transmitted by the UE 104-a. The UE 104-a may use a same filter for receiving the physical downlink channel for a set of consecutive slots based on the inferred time density value. Additionally, or alternatively, the NE 102-a may infer the time density corresponding to DMRSs sent via an uplink physical channel (e.g., PUSCH or PUCCH) from a measure of SRS symbols transmitted by the UE 104-a. The UE 104-a may use a same filter for transmitting the physical uplink channel for a set of consecutive slots based on the inferred time density value. The UE 104-a and/or the NE 102-a may apply a similar approach to DMRSs transmitted via an uplink physical channel when implementing FDD. The NE 102-a may configure a value of β from a set of configured values based on the SRS symbols.

In some examples, for transmitting signaling according to a time density of DMRS symbols (e.g., a density of DMRS symbols in the time domain) for downlink physical channels (e.g., a PDSCH or a PDCCH) with FDD, the UE 104-a measures the one or more CSI-RS symbols received at the UE 104-a. The UE 104-a transmits a CSI report 1110 that indicates the time density value β based on the received one or more CSI-RS symbols across multiple slots. In some cases, the UE 104-a includes a set of parameters in the CSI report 1110 that indicate an autocorrelation of the channel in the time domain or Doppler domain. The NE 102-a applies a precoding function to DMRSs sent to the UE 104-a via a downlink physical channel (e.g., PDSCH or PDCCH) based on the received CSI report 1110. The NE 102-a may configure the time density of the DMRSs sent via the downlink physical channel at the UE 104-a via control signaling (e.g., a DCI, RRC signaling, a MAC-CE). In some examples, the indication of the time density corresponds to a report quantity associated with a CSI configuration.

The UE 104-a may be configured with reporting a time density value β, which identifies the channel coherence time per layer, or average or worst case across layers. In some cases, the NE 102-a infers (e.g., determines, identifies, selects) a value of the time density from one or more CSI parameter values within the PMI reported by the UE 104-a. In some examples, the UE 104-a receives DMRSs sent via a downlink physical channel (e.g., PDSCH or PDCCH) over alternating slots if the downlink physical channel is received over multiple slots. For example, a time density value of DMRS symbols of one half

$$( e . g . , 0.5 , \frac{1}{2} )$$

corresponds to the UE 104-a receiving the DMRS symbols over every other slot. That is, the UE 104-a may monitor for and receive DMRS symbols over slots with even identifier or index values and may not monitor for or receive DMRS symbols over slots with odd identifier or index values. Additionally, or alternatively, the NE 102-a may transmit DMRS symbols via an uplink physical channel (e.g., PUSCH or PUCCH) over alternating slots if the uplink physical channel is transmitted over multiple slots. For example, a time density value of DMRS symbols of one half

$$( e . g . , 0.5 , \frac{1}{2} )$$

corresponds to the UE 104-a transmitting the DMRS symbols over every other slot. That is, the UE 104-a transmits the DMRS symbols over slots with even identifier or index values and does not transmit (e.g., cancels transmission, refrains from transmitting) the DMRS symbols over slots with odd identifier or index values.

In some cases, the NE 102-a schedules the UE 104-a to receive N′TBs or N′ codewords over N.k slots with a single trigger message. The UE 104-a may receive one or more DMRS symbols over a slot associated with a slot of the N.k slots associated with the N′TBs or N′ codewords. Additionally, or alternatively, the UE 104-a may receive few or no (e.g., less than a threshold value) DMRS symbols over a remainder of slots corresponding to a second subset of slots of the N.k slots associated with the N′TBs or N′ codewords. For example, the single trigger message is a DCI signal scheduling multiple PDSCH receptions, where a spacing between two receptions is k slots, and k is indicated in the DCI signal. Additionally, or alternatively, the single trigger message is a SPS trigger scheduling multiple PDSCH receptions in a periodic manner. Additionally, or alternatively, a value of k is a periodicity value associated with a configuration of the SPS. Additionally, or alternatively, a value of k is a repetition value associated with multiple reception occasions of the N′TBs or N′ codewords. Additionally, or alternatively, the single trigger message corresponds to a PDCCH configuration that identifies PDCCH reception conditions. Additionally, or alternatively, N is equal to N′. Additionally, or alternatively, N is an integer multiple of N′. Additionally, or alternatively, N′ is equal to one.

In some examples, the NE 102-a schedules the UE 104-a to transmit N′TBs or N′ codewords over N.k slots with a single trigger message. The UE 104-a may transmit one or more DMRS symbols over a first subset of slots of the N.k slots associated with the N′TBs or N′ codewords. Additionally, or alternatively, the UE 104-a may transmit few or no (e.g., less than a threshold value) DMRS symbols over a remainder of slots corresponding to a second subset of slots of the N.k slots associated with the N′TBs or N′ codewords. Additionally, or alternatively, the single trigger message is a DCI signal scheduling multiple PUSCH transmissions, where a spacing between two transmissions is k slots, and k is indicated in the DCI signal. Additionally, or alternatively, the single trigger message is a CG PUSCH trigger scheduling multiple PUSCH transmissions in a periodic manner, where a periodicity value k is configured within a configuration associated with the CG of the PUSCH. Additionally, or alternatively, a value of k is a periodicity value associated with a configuration of the CG PUSCH. Additionally, or alternatively, a value of k is a repetition value associated with multiple transmission occasions of the N′TBs or N′ codewords. Additionally, or alternatively, the single trigger message corresponds to a PUCCH configuration that identifies PUCCH transmission conditions. Additionally, or alternatively, N is equal to N′. Additionally, or alternatively, N is an integer multiple of N′. Additionally, or alternatively, N′ is equal to one.

In some cases, a first set of slots including data signal over a shared channel or control signal over a control channel also include DMRS symbols, constitute NZP DMRS. In some other cases, a second set of slots including data signal or control signal but not including DMRS symbols, constitute ZP DMRS. That is, the ZP DMRS corresponding to blank symbols or symbols that are otherwise used for data signal or control signal transmission or reception by the UE 104-a over uplink or downlink resources, respectively. The ZP DMRS in the second set of slots may be QCLed with an NZP DMRS received or transmitted, respectively, in a last slot in the first set of slots. The QCL may be of Type-A, corresponding to average delay, delay spread, Doppler shift, Doppler spread, as well as QCL of Type-D, corresponding to a spatial filter at the UE 104-a side, the NE 102-a side or both. In some other examples, the QCL may be of a type that includes all possible sets of large-scale parameters. The NZP DMRS corresponding to a first slot being QCLed with a ZP DMRS corresponding to a second slot indicates that a set of channel characteristics, channel estimation scheme, signal demodulation scheme, transmission scheme or reception, or any combination thereof, are the same for the first slot and the second slot. The data signal may be a PDSCH received at the UE 104-a, or a PUSCH transmitted by the UE 104-a. The control signal may be a PDCCH received at the UE 104-a, or a PUCCH transmitted by the UE 104-a.

In some other cases, the NE 102-a may transmit an indicator of a presence of DMRS symbols to the UE 104-a (e.g., as the density values for DMRS symbols 1106). The indicator having a value of 1 corresponds to the DMRS symbols being present in the corresponding slot, and the indicator having a value of 0 corresponds to the DMRS symbols being absent from (e.g., not being present) the corresponding slot. Additionally, or alternatively, the indicator may be in a form of a parameter corresponding to a DMRS status. The NE 102-a may set a value of the parameter to either “present,” “absent,” or “sparse,” among other examples, corresponding to the DMRS symbols being present, absent, or present with a reduced number of symbols compared with a default scenario, respectively. The default scenario may correspond to a density value of 1 (e.g., each resource includes at least one DMRS symbol).

In some cases, if the DMRS symbols are associated with a PDSCH scheduled via a PDCCH, then the NE 102-a reports the indicator within a field in a DCI used for scheduling PDSCH. Additionally, or alternatively, if the DMRS symbols are associated with a PUSCH scheduled via a PDCCH, then the NE 102-a reports the indicator within a field in a DCI used for scheduling PUSCH. Additionally, or alternatively, if the DMRS symbols are associated with a PDSCH scheduled via an SPS trigger, then the NE 102-a reports the indicator within a field in an SPS PDSCH trigger. Additionally, or alternatively, if the DMRS symbols are associated with a PUSCH scheduled via a configuration, then the NE 102-a reports the indicator within a field in a CG PUSCH trigger. Additionally, or alternatively, if the DMRS symbols are associated with a PDCCH, then the NE 102-a reports the indicator within a field in a PDCCH configuration message. Additionally, or alternatively, if the DMRS symbols are associated with a PUCCH, then the NE 102-a reports the indicator within a field in a PUCCH configuration message.

In some cases, for slots or RBs that are not associated with a DMRS, the UE 104-a reuses the most recent DMRS sent over the same antenna ports for PDSCH starting with a same antenna port number. For example, the UE 104-a reuses a DCI field “antenna port” or “number of layers” parameter of a prior occasion with the DMRS present. An inference of a set of channel characteristics, channel estimation scheme, signal demodulation scheme, transmission scheme or reception, or any combination thereof, of a slot or RB not including a DMRS symbol is based on a configuration indicated to the UE 104-a. In some examples, if the DMRS symbols are associated with a PDSCH, then the NE 102-a indicates the configuration via at least one of a downlink DMRS configuration or a PDSCH configuration over RRC signaling. Additionally, or alternatively, if the DMRS symbols are associated with a PUSCH, then the NE 102-a indicates the configuration via at least one of an uplink DMRS configuration or a PUSCH configuration over RRC signaling. Additionally, or alternatively, if the DMRS symbols are associated with a PDCCH, then the NE 102-a indicates the configuration via at least one of a downlink DMRS configuration or a PDCCH configuration over RRC signaling. Additionally, or alternatively, if the DMRS symbols are associated with a PUCCH, then the NE 102-a indicates the configuration via at least one of an uplink DMRS configuration or a PUCCH configuration over RRC signaling.

In some other cases, a configuration or trigger associated with a downlink physical channel reception (e.g., a PDSCH reception or PDCCH reception) is expected to be invalidated or deactivated after a UE 104-a transmits an indication of a decoding failure of a downlink signal (e.g., PDSCH, PDCCH). The invalidation or deactivation may be applied after a time window defined (e.g., configured, preconfigured) by the NE 102-a or set by a rule that is known to both the UE 104-a and the NE 102-a. Additionally, or alternatively, a configuration or trigger associated with an uplink physical channel transmission (e.g., a PUSCH transmission or a PUCCH transmission) is expected to be invalidated or deactivated after a UE 104-a receives an indication of a decoding failure of an uplink signal (e.g., PUSCH, PUCCH). The invalidation or deactivation may be applied after a time window defined (e.g., configured, preconfigured) by the NE 102-a or set by a rule that is known to both the UE 104-a and the NE 102-a. For example, if the time window lapses or the rule is satisfied, then the UE 104-a and/or the NE 102-a may return to transmitting the DMRS symbols according to a default density value, rather than the density values for the DMRS symbols 1106 indicated by the NE 102-a. The default density value may be a value of one, such that each resource (e.g., RB or slot) includes at least one DMRS symbol.

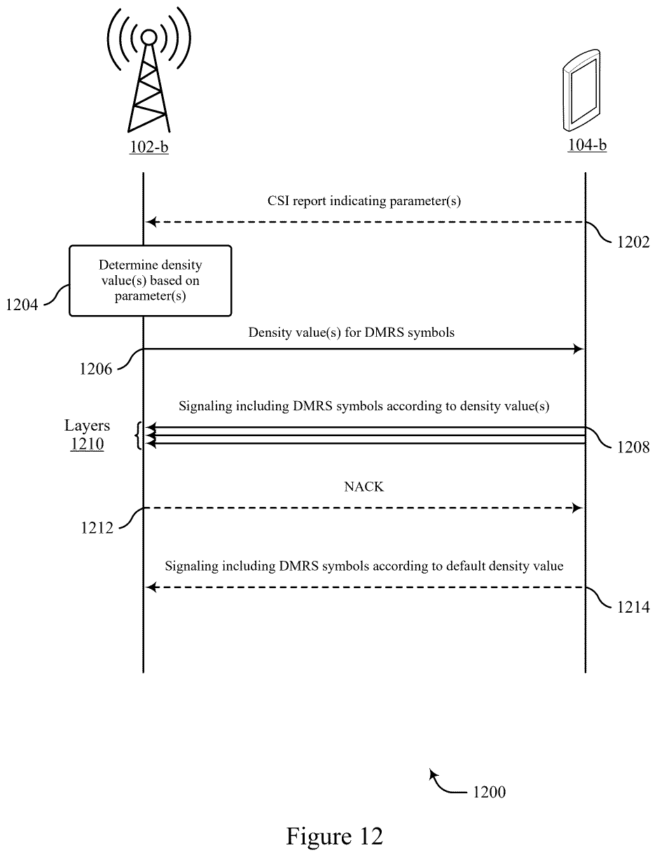

FIG. 12 illustrate an example of a signaling diagram 1200 in accordance with aspects of the present disclosure. In some examples, the signaling diagram 1200 implements or is implemented by aspects of the wireless communications system 1100 implements or is implemented by aspects of the wireless communications system 100, the scenario 200, the aperiodic trigger state 300, the RRC configuration 400, the RRC configuration 500, the scenario 600, the IE 700, the IE 800, the DMRS configuration 900, the DMRS configuration 1000, and the wireless communications system 1100. The signaling diagram 1200 may implement or be implemented by a UE 104-b and an NE 102-b, which may be examples of the corresponding devices as described with reference to FIGS. 1 and 11. For example, the NE 102-b may provide the UE 104-b with one or more density values for transmitting DMRS symbols across resources via a physical channel. Alternative examples of the following may be implemented, where some processes are performed in a different order than described or are not performed. In some cases, processes may include additional features not mentioned below, or further processes may be added.

In some cases, at 1202, the UE 104-b transmits a CSI report to the NE 102-b. The CSI report includes one or more parameters including at least one of a channel flatness factor or a channel coherence period across at least one of a time domain and a frequency domain.

At 1204, the NE 102-b determines one or more density values based on the one or more parameters received in the CSI report. The one or more density values are associated with one or more DMRS symbols across a set of resources associated with a physical channel. For example, the density value may indicate a numerical quantity of DMRS symbols per set of resources (e.g., RBs, slots) for the UE 104-b and/or the NE 102-b to include in a physical channel transmission. That is, the one or more density values correspond to respective portions of resources occupied by the one or more DMRS symbols. The physical channel transmission may include transmissions across a set of layers (e.g., spatial layers, spatial streams), where each layer is representative and/or is mapped to a port (e.g., DMRS port, antenna port) at a transmitting device. In some cases, the physical channel may be a PDSCH, a PDCCH, a PUSCH, or a PUCCH, among other examples.

At 1206, the NE 102-b transmits signaling to the UE 104-b that indicates the one or more density values. The signaling may include at least one of a DCI scheduling a PDSCH, a DCI scheduling a PUSCH, an SPS PDSCH trigger, a CG PUSCH trigger, a PDCCH configuration message, or a PUCCH configuration message. The one or more density values may include a frequency density value. If the density values include a frequency density value, then the resources used to transmit the DMRS symbols may include a set of RBs. The respective portions of the resources may include alternating RBs if the frequency density value is one half. Alternatively or additionally, the one or more density values may include a time density value. If the density values include a time density value, then the resources used to transmit the DMRS symbols may include a set of slots. The respective portions of the resources may include alternating slots of the set of slots if the time density value is one half.

A density value of the one or more density values may correspond to a partitioning of the set of resources into two subsets of resources. A first subset of resources of the two subsets of resources may include a first numerical quantity of DMRS symbols per resource, and a second subset of resources of the two subsets of resources may include a second numerical quantity of DMRS symbols per resource. A ratio of a numerical quantity of resources in the first subset of resources and a total numerical quantity of resources in the set of resources may be defined by the density value. In some cases, the signaling may include a QCL relationship that associates a first set of DMRS symbols in the first subset of resources with a second set of DMRS symbols in the second subset of resources. The QCL relationship may be with respect to one or more characteristics including at least one of an average delay, a delay spread, a Doppler shift, a Doppler spread, a spatial transmit filter or a spatial receive filter. A QCL relationship may refer to an association between different sets of DMRS symbols across subsets of resources (e.g., time-frequency resources). The QCL relationship may indicate that one or more channel properties are similar or can be inferred between the associated DMRS symbols, even if the DMRS symbols are transmitted on different resources. The QCL relationship may be defined with respect to one or more characteristics, which may include average delay, delay spread, Doppler shift, Doppler spread, spatial transmit filter, or spatial receive filter, among other examples.

In some cases, the first numerical quantity of DMRS symbols per resource associated with the first subset of resources may be greater than the second numerical quantity of DMRS symbols per resource associated with the second subset of resources. Additionally, or alternatively, the second numerical quantity of DMRS symbols per resource may be zero. Additionally, or alternatively, the second subset of resources may include a ZP DMRS. Symbols corresponding to the ZP DMRS in the second subset of resources are associated with DMRS symbols in the first subset of resources via a QCL relationship with respect to the one or more characteristics.

At 1208, the UE 104-b transmits signaling including DMRS symbols to the NE 102-b according to the one or more density values. The UE 104-b may transmit the signaling across multiple layers 1210 (e.g., using multiple ports). The signaling may be one or more TBs, where at least a portion of the TBs include DMRS symbols.

In some cases, at 1212, the NE 102-b transmits feedback including a NACK corresponding to a received TB to the UE 104-b. In some examples, at 1214, in response to the NACK, the UE 104-b transmits signaling that includes DMRS symbols according to a default density value rather than the previously determined density values. The default density value may be one. The NE 102-b receives one or more additional DMRS symbols according to the default density value associated with the set of ports of the one or more DMRS symbols. The UE 104-b may apply the default density value to the one or more additional DMRS symbols a time period after the feedback is received.

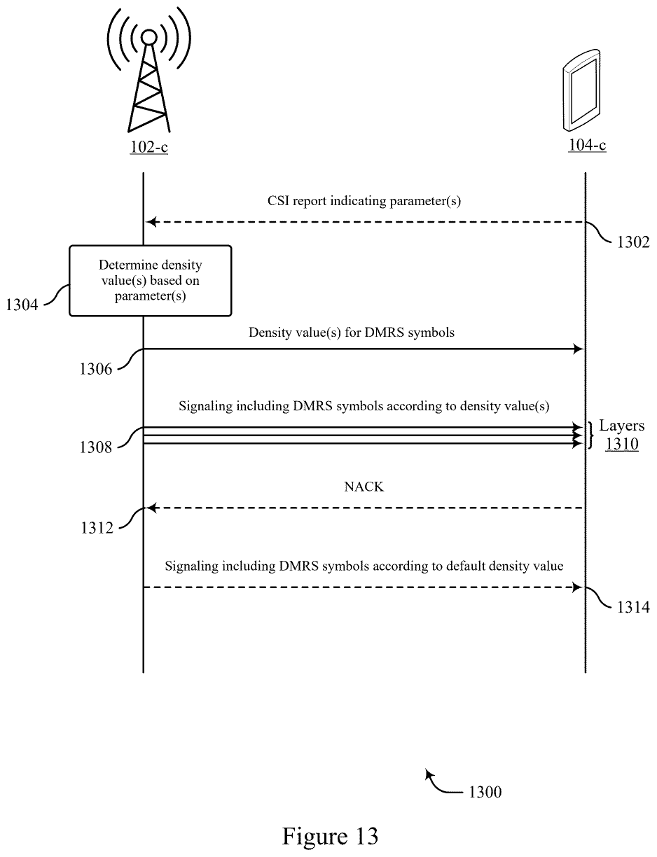

FIG. 13 illustrate an example of a signaling diagram 1300 in accordance with aspects of the present disclosure. In some examples, the signaling diagram 1300 implements or is implemented by aspects of the wireless communications system 1100 implements or is implemented by aspects of the wireless communications system 100, the scenario 200, the aperiodic trigger state 300, the RRC configuration 400, the RRC configuration 500, the scenario 600, the IE 700, the IE 800, the DMRS configuration 900, the DMRS configuration 1000, the wireless communications system 1100, and the signaling diagram 1200. The signaling diagram 1300 may implement or be implemented by a UE 104-c and an NE 102-c, which may be examples of the corresponding devices as described with reference to FIGS. 1, 11, and 12. For example, the NE 102-c may provide the UE 104-c with one or more density values for receiving DMRS symbols across resources via a physical channel. Alternative examples of the following may be implemented, where some processes are performed in a different order than described or are not performed. In some cases, processes may include additional features not mentioned below, or further processes may be added.

In some cases, at 1302, the UE 104-c transmits a CSI report to the NE 102-c. The CSI report includes one or more parameters including at least one of a channel flatness factor or a channel coherence period across at least one of a time domain and a frequency domain.

At 1304, the NE 102-c determines one or more density values based on the one or more parameters received in the CSI report. The one or more density values are associated with one or more DMRS symbols across a set of resources associated with a physical channel. For example, the density value may indicate a numerical quantity of DMRS symbols per set of resources (e.g., RBs, slots) for the UE 104-c and/or the NE 102-c to include in a physical channel transmission. That is, the one or more density values correspond to respective portions of resources occupied by the one or more DMRS symbols. The physical channel transmission may include transmissions across a set of layers (e.g., spatial layers, spatial streams), where each layer is representative and/or is mapped to a port (e.g., DMRS port, antenna port) at a transmitting device. In some cases, the physical channel may be a PDSCH, a PDCCH, a PUSCH, or a PUCCH, among other examples.

At 1306, the NE 102-c transmits signaling to the UE 104-c that indicates the one or more density values. The signaling may include at least one of a DCI scheduling a PDSCH, a DCI scheduling a PUSCH, an SPS PDSCH trigger, a CG PUSCH trigger, a PDCCH configuration message, or a PUCCH configuration message. The one or more density values may include a frequency density value. If the density values include a frequency density value, then the resources used to transmit the DMRS symbols may include a set of RBs. The respective portions of the resources may include alternating RBs if the frequency density value is one half. Alternatively or additionally, the one or more density values may include a time density value. If the density values include a time density value, then the resources used to transmit the DMRS symbols may include a set of slots. The respective portions of the resources may include alternating slots of the set of slots if the time density value is one half.

A density value of the one or more density values may correspond to a partitioning of the set of resources into two subsets of resources. A first subset of resources of the two subsets of resources may include a first numerical quantity of DMRS symbols per resource, and a second subset of resources of the two subsets of resources may include a second numerical quantity of DMRS symbols per resource. A ratio of a numerical quantity of resources in the first subset of resources and a total numerical quantity of resources in the set of resources may be defined by the density value. In some cases, the signaling may include a QCL relationship that associates a first set of DMRS symbols in the first subset of resources with a second set of DMRS symbols in the second subset of resources. The QCL relationship may be with respect to one or more characteristics including at least one of an average delay, a delay spread, a Doppler shift, a Doppler spread, a spatial transmit filter or a spatial receive filter. A QCL relationship may refer to an association between different sets of DMRS symbols across subsets of resources (e.g., time-frequency resources). The QCL relationship may indicate that one or more channel properties are similar or can be inferred between the associated DMRS symbols, even if the DMRS symbols are transmitted on different resources. The QCL relationship may be defined with respect to one or more characteristics, which may include average delay, delay spread, Doppler shift, Doppler spread, spatial transmit filter, or spatial receive filter, among other examples.

In some cases, the first numerical quantity of DMRS symbols per resource associated with the first subset of resources may be greater than the second numerical quantity of DMRS symbols per resource associated with the second subset of resources. Additionally, or alternatively, the second numerical quantity of DMRS symbols per resource may be zero. Additionally, or alternatively, the second subset of resources may include a ZP DMRS. Symbols corresponding to the ZP DMRS in the second subset of resources are associated with DMRS symbols in the first subset of resources via a QCL relationship with respect to the one or more characteristics.

At 1308, the NE 102-c transmits signaling including DMRS symbols to the UE 104-c according to the one or more density values. The NE 102-c may transmit the signaling across multiple layers 1310 (e.g., using multiple ports). The signaling may be one or more TBs, where at least a portion of the TBs include DMRS symbols.

In some cases, at 1312, the UE 104-c transmits feedback including a NACK corresponding to a received TB to the NE 102-c. A NACK may indicate that a TB and/or a portion of the TB is not successfully received and decoded. In some examples, at 1314, in response to the NACK, the NE 102-c transmits signaling that includes DMRS symbols according to a default density value rather than the previously determined density values. The default density value may be one. The UE 104-c receives one or more additional DMRS symbols according to the default density value associated with the set of ports of the one or more DMRS symbols. The NE 102-c may apply the default density value to the one or more additional DMRS symbols a time period after the feedback is received.

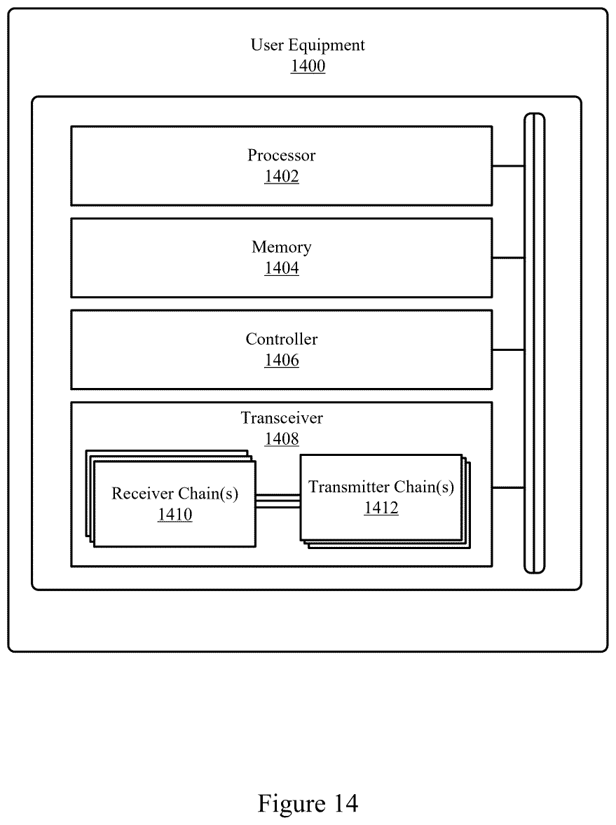

FIG. 14 illustrates an example of a UE 1400 in accordance with aspects of the present disclosure. The UE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the UE 1400 to perform various functions of the present disclosure.

The memory 1404 may include volatile or non-volatile memory. The memory 1404 may store computer-readable, computer-executable code including instructions when executed by the processor 1402 cause the UE 1400 to perform various functions described herein. The code may be stored in a non-transitory computer-readable medium such as the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the UE 1400 to perform one or more of the functions described herein (e.g., executing, by the processor 1402, instructions stored in the memory 1404). For example, the processor 1402 may support wireless communication at the UE 1400 in accordance with examples as disclosed herein. The UE 1400 may be configured to or operable to support a means for receiving signaling that indicates one or more density values associated with one or more DMRS symbols across a set of resources associated with a physical channel, where the physical channel is associated with a set of layers corresponding to a set of ports of the one or more DMRS symbols, and where the one or more density values correspond to respective portions of resources of the set of resources occupied by the one or more DMRS symbols and transmitting or receiving, via the physical channel, the one or more DMRS symbols based on the one or more density values.

Additionally, the UE 1400 may be configured to support any one or combination of means for the one or more density values include a frequency density value, and where the set of resources includes a set of RBs. Additionally, or alternatively, the UE 1400 may be configured to or operable to support the respective portions of the resources include alternating RBs of the set of RBs based on the frequency density value being one half. Additionally, or alternatively, the UE 1400 may be configured to or operable to support the one or more density values include a time density value, and where the set of resources includes a set of slots. Additionally, or alternatively, the UE 1400 may be configured to or operable to support the respective portions of the resources include alternating slots of the set of slots based on the time density value being one half. Additionally, or alternatively, the UE 1400 may be configured to or operable to support the signaling includes one or more parameters that indicate a presence of a DMRS symbol in the respective portions of resources of the set of resources, and where the signaling includes at least one of a DCI scheduling a PDSCH, a DCI scheduling a PUSCH, an SPS PDSCH trigger, a CG PUSCH trigger, a PDCCH configuration message, or a PUCCH configuration message.

Additionally, or alternatively, the UE 1400 may be configured to or operable to support means for transmitting, prior to receiving the signaling, additional signaling that indicates one or more parameters, where the one or more density values are based on the one or more parameters. Additionally, or alternatively, the UE 1400 may be configured to or operable to support the additional signaling includes a CSI report, and where the one or more parameters include at least one of a channel flatness factor or a channel coherence period across at least one of a time domain and a frequency domain. Additionally, or alternatively, the UE 1400 may be configured to or operable to support a density value of the one or more density values corresponds to a partitioning of the set of resources into two subsets of resources, and where a first subset of resources of the two subsets of resources includes a first numerical quantity of DMRS symbols per resource, and where a second subset of resources of the two subsets of resources includes a second numerical quantity of DMRS symbols per resource. Additionally, or alternatively, the UE 1400 may be configured to or operable to support a ratio of a numerical quantity of resources in the first subset of resources and a total numerical quantity of resources in the set of resources is based on the density value

Additionally, or alternatively, the UE 1400 may be configured to or operable to support the signaling includes a QCL relationship that associates a first set of DMRS symbols in the first subset of resources with a second set of DMRS symbols in the second subset of resources, and where the QCL relationship is with respect to one or more characteristics including at least one of an average delay, a delay spread, a Doppler shift, a Doppler spread, a spatial transmit filter or a spatial receive filter. Additionally, or alternatively, the UE 1400 may be configured to or operable to support the first numerical quantity of DMRS symbols per resource associated with the first subset of resources is greater than the second numerical quantity of DMRS symbols per resource associated with the second subset of resources. Additionally, or alternatively, the UE 1400 may be configured to or operable to support the second numerical quantity of DMRS symbols per resource is zero. Additionally, or alternatively, the UE 1400 may be configured to or operable to support the second subset of resources includes a ZP DMRS, where symbols corresponding to the ZP DMRS in the second subset of resources are associated with DMRS symbols in the first subset of resources via a QCL relationship with respect to one or more characteristics, and where the one or more characteristics include at least one of an average delay, a delay spread, a Doppler shift, a Doppler spread, a spatial transmit filter, or a spatial receive filter.

Additionally, or alternatively, the UE 1400 may be configured to or operable to support means for receiving feedback including a NACK corresponding to a transmitted TB or transmitting the feedback including the NACK corresponding to a received TB and transmitting or receiving one or more additional DMRS symbols based on a default density value associated with the set of ports of the one or more DMRS symbols. Additionally, or alternatively, the UE 1400 may be configured to or operable to support the default density value is one. Additionally, or alternatively, the UE 1400 may be configured to or operable to support means for applying the default density value to the one or more additional DMRS symbols a time period after the feedback is received or transmitted. Additionally, or alternatively, the UE 1400 may be configured to or operable to support the physical channel is a PDSCH, a PDCCH, a PUSCH, or a PUCCH.

Additionally, or alternatively, the UE 1400 may support at least one memory (e.g., the memory 1404) and at least one processor (e.g., the processor 1402) coupled with the at least one memory and configured to cause the UE 1400 to receive signaling that indicates one or more density values associated with one or more DMRS symbols across a set of resources associated with a physical channel, where the physical channel is associated with a set of layers corresponding to a set of ports of the one or more DMRS symbols, and where the one or more density values correspond to respective portions of resources of the set of resources occupied by the one or more DMRS symbols and transmit or receive, via the physical channel, the one or more DMRS symbols based on the one or more density values.

Additionally, the UE 1400 may be configured to support any one or combination of the one or more density values include a frequency density value, and where the set of resources includes a set of RBs. Additionally, the UE 1400 may be configured to support any one or combination of the respective portions of the resources include alternating RBs of the set of RBs based on the frequency density value being one half. Additionally, the UE 1400 may be configured to support any one or combination of the one or more density values include a time density value, and where the set of resources includes a set of slots. Additionally, the UE 1400 may be configured to support any one or combination of the respective portions of the resources include alternating slots of the set of slots based on the time density value being one half. Additionally, the UE 1400 may be configured to support any one or combination of the signaling includes one or more parameters that indicate a presence of a DMRS symbol in the respective portions of resources of the set of resources, and where the signaling includes at least one of a DCI scheduling a PDSCH, a DCI scheduling a PUSCH, an SPS PDSCH trigger, a CG PUSCH trigger, a PDCCH configuration message, or a PUCCH configuration message.

Additionally, the at least one processor may be further configured to cause the UE 1400 to transmit, prior to receiving the signaling, additional signaling that indicates one or more parameters, where the one or more density values are based on the one or more parameters. Additionally, the UE 1400 may be configured to support any one or combination of the additional signaling includes a CSI report, and where the one or more parameters include at least one of a channel flatness factor or a channel coherence period across at least one of a time domain and a frequency domain. Additionally, the UE 1400 may be configured to support any one or combination of a density value of the one or more density values corresponds to a partitioning of the set of resources into two subsets of resources, and where a first subset of resources of the two subsets of resources includes a first numerical quantity of DMRS symbols per resource, and where a second subset of resources of the two subsets of resources includes a second numerical quantity of DMRS symbols per resource. Additionally, the UE 1400 may be configured to support any one or combination of a ratio of a numerical quantity of resources in the first subset of resources and a total numerical quantity of resources in the set of resources is based on the density value.

Additionally, the UE 1400 may be configured to support any one or combination of the signaling includes a QCL relationship that associates a first set of DMRS symbols in the first subset of resources with a second set of DMRS symbols in the second subset of resources, and where the QCL relationship is with respect to one or more characteristics including at least one of an average delay, a delay spread, a Doppler shift, a Doppler spread, a spatial transmit filter or a spatial receive filter. Additionally, the UE 1400 may be configured to support any one or combination of the first numerical quantity of DMRS symbols per resource associated with the first subset of resources is greater than the second numerical quantity of DMRS symbols per resource associated with the second subset of resources. Additionally, the UE 1400 may be configured to support any one or combination of the second numerical quantity of DMRS symbols per resource is zero. Additionally, the UE 1400 may be configured to support any one or combination of the second subset of resources includes a ZP DMRS, where symbols corresponding to the ZP DMRS in the second subset of resources are associated with DMRS symbols in the first subset of resources via a QCL relationship with respect to one or more characteristics, and where the one or more characteristics include at least one of an average delay, a delay spread, a Doppler shift, a Doppler spread, a spatial transmit filter, or a spatial receive filter.

Additionally, the at least one processor may be further configured to cause the UE 1400 to receive feedback including a NACK corresponding to a transmitted TB or transmit the feedback including the NACK corresponding to a received TB and transmit or receive one or more additional DMRS symbols based on a default density value associated with the set of ports of the one or more DMRS symbols. Additionally, the UE 1400 may be configured to support any one or combination of the default density value is one. Additionally, the at least one processor may be further configured to cause the UE 1400 to apply the default density value to the one or more additional DMRS symbols a time period after the feedback is received or transmitted. Additionally, the UE 1400 may be configured to support any one or combination of the physical channel is a PDSCH, a PDCCH, a PUSCH, or a PUCCH.

The controller 1406 may manage input and output signals for the UE 1400. The controller 1406 may also manage peripherals not integrated into the UE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the UE 1400 may include at least one transceiver 1408. In some other implementations, the UE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas to receive a signal over the air or wireless medium. The receiver chain 1410 may include at least one amplifier (e.g., a low-noise amplifier (LNA)) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

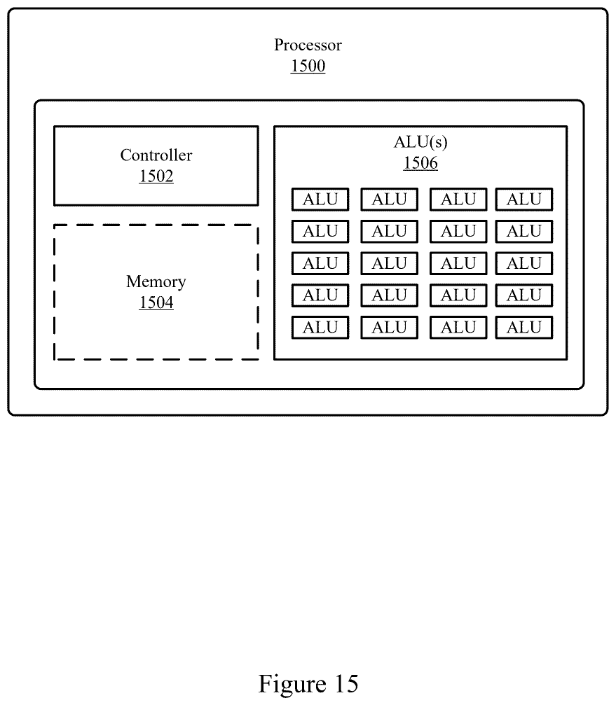

FIG. 15 illustrates an example of a processor 1500 in accordance with aspects of the present disclosure. The processor 1500 may be an example of a processor configured to perform various operations in accordance with examples as described herein. The processor 1500 may include a controller 1502 configured to perform various operations in accordance with examples as described herein. The processor 1500 may optionally include at least one memory 1504, which may be, for example, an L1/L2/L3 cache. Additionally, or alternatively, the processor 1500 may optionally include one or more arithmetic-logic units (ALUs) 1506. One or more of these components may be in electronic communication or otherwise coupled (e.g., operatively, communicatively, functionally, electronically, electrically) via one or more interfaces (e.g., buses).

The processor 1500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1502 may be configured to manage and coordinate various operations (e.g., signaling, receiving, obtaining, retrieving, transmitting, outputting, forwarding, storing, determining, identifying, accessing, writing, reading) of the processor 1500 to cause the processor 1500 to support various operations in accordance with examples as described herein. For example, the controller 1502 may operate as a control unit of the processor 1500, generating control signals that manage the operation of various components of the processor 1500. These control signals include enabling or disabling functional units, selecting data paths, initiating memory access, and coordinating timing of operations.

The controller 1502 may be configured to fetch (e.g., obtain, retrieve, receive) instructions from the memory 1504 and determine subsequent instruction(s) to be executed to cause the processor 1500 to support various operations in accordance with examples as described herein. The controller 1502 may be configured to track memory addresses of instructions associated with the memory 1504. The controller 1502 may be configured to decode instructions to determine the operation to be performed and the operands involved. For example, the controller 1502 may be configured to interpret the instruction and determine control signals to be output to other components of the processor 1500 to cause the processor 1500 to support various operations in accordance with examples as described herein. Additionally, or alternatively, the controller 1502 may be configured to manage flow of data within the processor 1500. The controller 1502 may be configured to control transfer of data between registers, ALUs 1506, and other functional units of the processor 1500.

The memory 1504 may include one or more caches (e.g., memory local to or included in the processor 1500 or other memory, such as RAM, ROM, DRAM, SDRAM, SRAM, MRAM, flash memory, etc. In some implementations, the memory 1504 may reside within or on a processor chipset (e.g., local to the processor 1500). In some other implementations, the memory 1504 may reside external to the processor chipset (e.g., remote to the processor 1500).

The memory 1504 may store computer-readable, computer-executable code including instructions that, when executed by the processor 1500, cause the processor 1500 to perform various functions described herein. The code may be stored in a non-transitory computer-readable medium such as system memory or another type of memory. The controller 1502 and/or the processor 1500 may be configured to execute computer-readable instructions stored in the memory 1504 to cause the processor 1500 to perform various functions. For example, the processor 1500 and/or the controller 1502 may be coupled with or to the memory 1504, the processor 1500, and the controller 1502, and may be configured to perform various functions described herein. In some examples, the processor 1500 may include multiple processors and the memory 1504 may include multiple memories. One or more of the multiple processors may be coupled with one or more of the multiple memories, which may, individually or collectively, be configured to perform various functions herein.

The one or more ALUs 1506 may be configured to support various operations in accordance with examples as described herein. In some implementations, the one or more ALUs 1506 may reside within or on a processor chipset (e.g., the processor 1500). In some other implementations, the one or more ALUs 1506 may reside external to the processor chipset (e.g., the processor 1500). One or more ALUs 1506 may perform one or more computations such as addition, subtraction, multiplication, and division on data. For example, one or more ALUs 1506 may receive input operands and an operation code, which determines an operation to be executed. One or more ALUs 1506 may be configured with a variety of logical and arithmetic circuits, including adders, subtractors, shifters, and logic gates, to process and manipulate the data according to the operation. Additionally, or alternatively, the one or more ALUs 1506 may support logical operations such as AND, OR, exclusive-OR (XOR), not-OR (NOR), and not-AND (NAND), enabling the one or more ALUs 1506 to handle conditional operations, comparisons, and bitwise operations.

The processor 1500 may support wireless communication in accordance with examples as disclosed herein. The processor 1500 may be configured to or operable to support at least one controller (e.g., the controller 1502) coupled with at least one memory (e.g., the memory 1504) and configured to cause the processor 1500 to receive signaling that indicates one or more density values associated with one or more DMRS symbols across a set of resources associated with a physical channel, where the physical channel is associated with a set of layers corresponding to a set of ports of the one or more DMRS symbols, and where the one or more density values correspond to respective portions of resources of the set of resources occupied by the one or more DMRS symbols; and transmit or receive, via the physical channel, the one or more DMRS symbols based on the one or more density values.

Additionally, the processor 1500 may be configured to or operable to support any one or combination of the one or more density values include a frequency density value, and where the set of resources includes a set of RBs. Additionally, the processor 1500 may be configured to support any one or combination of the respective portions of the resources include alternating RBs of the set of RBs based on the frequency density value being one half. Additionally, the processor 1500 may be configured to support any one or combination of the one or more density values include a time density value, and where the set of resources includes a set of slots. Additionally, the processor 1500 may be configured to support any one or combination of the respective portions of the resources include alternating slots of the set of slots based on the time density value being one half. Additionally, the processor 1500 may be configured to support any one or combination of the signaling includes one or more parameters that indicate a presence of a DMRS symbol in the respective portions of resources of the set of resources, and where the signaling includes at least one of a DCI scheduling a PDSCH, a DCI scheduling a PUSCH, an SPS PDSCH trigger, a CG PUSCH trigger, a PDCCH configuration message, or a PUCCH configuration message.

Additionally, the at least one controller may be further configured to cause the processor 1500 to transmit, prior to receiving the signaling, additional signaling that indicates one or more parameters, where the one or more density values are based on the one or more parameters. Additionally, the processor 1500 may be configured to support any one or combination of the additional signaling includes a CSI report, and where the one or more parameters include at least one of a channel flatness factor or a channel coherence period across at least one of a time domain and a frequency domain. Additionally, the processor 1500 may be configured to support any one or combination of a density value of the one or more density values corresponds to a partitioning of the set of resources into two subsets of resources, and where a first subset of resources of the two subsets of resources includes a first numerical quantity of DMRS symbols per resource, and where a second subset of resources of the two subsets of resources includes a second numerical quantity of DMRS symbols per resource. Additionally, the processor 1500 may be configured to support any one or combination of a ratio of a numerical quantity of resources in the first subset of resources and a total numerical quantity of resources in the set of resources is based on the density value.

Additionally, the processor 1500 may be configured to support any one or combination of the signaling includes a QCL relationship that associates a first set of DMRS symbols in the first subset of resources with a second set of DMRS symbols in the second subset of resources, and where the QCL relationship is with respect to one or more characteristics including at least one of an average delay, a delay spread, a Doppler shift, a Doppler spread, a spatial transmit filter or a spatial receive filter. Additionally, the processor 1500 may be configured to support any one or combination of the first numerical quantity of DMRS symbols per resource associated with the first subset of resources is greater than the second numerical quantity of DMRS symbols per resource associated with the second subset of resources. Additionally, the processor 1500 may be configured to support any one or combination of the second numerical quantity of DMRS symbols per resource is zero. Additionally, the processor 1500 may be configured to support any one or combination of the second subset of resources includes a ZP DMRS, where symbols corresponding to the ZP DMRS in the second subset of resources are associated with DMRS symbols in the first subset of resources via a QCL relationship with respect to one or more characteristics, and where the one or more characteristics include at least one of an average delay, a delay spread, a Doppler shift, a Doppler spread, a spatial transmit filter, or a spatial receive filter.

Additionally, the at least one controller may be further configured to cause the processor 1500 to receive feedback including a NACK corresponding to a transmitted TB or transmit the feedback including the NACK corresponding to a received TB and transmit or receive one or more additional DMRS symbols based on a default density value associated with the set of ports of the one or more DMRS symbols. Additionally, the processor 1500 may be configured to support any one or combination of the default density value is one. Additionally, the at least one controller may be further configured to cause the processor 1500 to apply the default density value to the one or more additional DMRS symbols a time period after the feedback is received or transmitted. Additionally, the processor 1500 may be configured to support any one or combination of the physical channel is a PDSCH, a PDCCH, a PUSCH, or a PUCCH.

Additionally, the processor 1500 may be configured to or operable to support at least one controller (e.g., the controller 1502) coupled with at least one memory (e.g., the memory 1504) and configured to cause the processor 1500 to transmit signaling that indicates one or more density values associated with one or more DMRS symbols across a set of resources associated with a physical channel, where the physical channel is associated with a set of layers corresponding to a set of ports of the one or more DMRS symbols, and where the one or more density values correspond to respective portions of resources of the set of resources occupied by the one or more DMRS symbols and receive or transmit, via the physical channel, the one or more DMRS symbols based on the one or more density values.

Additionally, the processor 1500 may be configured to support any one or combination of the one or more density values include a frequency density value, and where the set of resources includes a set of RBs. Additionally, the processor 1500 may be configured to support any one or combination of the respective portions of the resources include alternating RBs of the set of RBs based on the frequency density value being one half. Additionally, the processor 1500 may be configured to support any one or combination of the one or more density values include a time density value, and where the set of resources includes a set of slots. Additionally, the processor 1500 may be configured to support any one or combination of the respective portions of the resources include alternating slots of the set of slots based on the time density value being one half. Additionally, the processor 1500 may be configured to support any one or combination of the signaling includes one or more parameters that indicate a presence of a DMRS symbol in the respective portions of resources of the set of resources, and where the signaling includes at least one of a DCI scheduling a PDSCH, a DCI scheduling a PUSCH, an SPS PDSCH trigger, a CG PUSCH trigger, a PDCCH configuration message, or a PUCCH configuration message.

Additionally, the at least one controller may be further configured to cause the processor 1500 to receive, prior to transmitting the signaling, additional signaling that indicates one or more parameters, where the one or more density values are based on the one or more parameters. Additionally, the processor 1500 may be configured to support any one or combination of the additional signaling includes a CSI report, and where the one or more parameters include at least one of a channel flatness factor or a channel coherence period across at least one of a time domain and a frequency domain. Additionally, the processor 1500 may be configured to support any one or combination of a density value of the one or more density values corresponds to a partitioning of the set of resources into two subsets of resources, and where a first subset of resources of the two subsets of resources includes a first numerical quantity of DMRS symbols per resource, and where a second subset of resources of the two subsets of resources includes a second numerical quantity of DMRS symbols per resource. Additionally, the processor 1500 may be configured to support any one or combination of a ratio of a numerical quantity of resources in the first subset of resources and a total numerical quantity of resources in the set of resources is based on the density value.

Additionally, the processor 1500 may be configured to support any one or combination of the signaling includes a QCL relationship that associates a first set of DMRS symbols in the first subset of resources with a second set of DMRS symbols in the second subset of resources, and where the QCL relationship is with respect to one or more characteristics including at least one of an average delay, a delay spread, a Doppler shift, a Doppler spread, a spatial transmit filter or a spatial receive filter. Additionally, the processor 1500 may be configured to support any one or combination of the first numerical quantity of DMRS symbols per resource associated with the first subset of resources is greater than the second numerical quantity of DMRS symbols per resource associated with the second subset of resources. Additionally, the processor 1500 may be configured to support any one or combination of the second numerical quantity of DMRS symbols per resource is zero. Additionally, the processor 1500 may be configured to support any one or combination of the second subset of resources includes a ZP DMRS, where symbols corresponding to the ZP DMRS in the second subset of resources are associated with DMRS symbols in the first subset of resources via a QCL relationship with respect to one or more characteristics, and where the one or more characteristics include at least one of an average delay, a delay spread, a Doppler shift, a Doppler spread, a spatial transmit filter, or a spatial receive filter.

Additionally, the at least one controller may be further configured to cause the processor 1500 to transmit feedback including a NACK corresponding to a received TB or receive the feedback including a NACK corresponding to a transmitted TB and receive or transmit one or more additional DMRS symbols based on a default density value associated with the set of ports of the one or more DMRS symbol. Additionally, the processor 1500 may be configured to support any one or combination of the default density value is one. Additionally, the at least one controller may be further configured to cause the processor 1500 to apply the default density value to the one or more additional DMRS symbols a time period after the feedback is transmitted or received. Additionally, the processor 1500 may be configured to support any one or combination of the physical channel is a PDSCH, a PDCCH, a PUSCH, or a PUCCH.

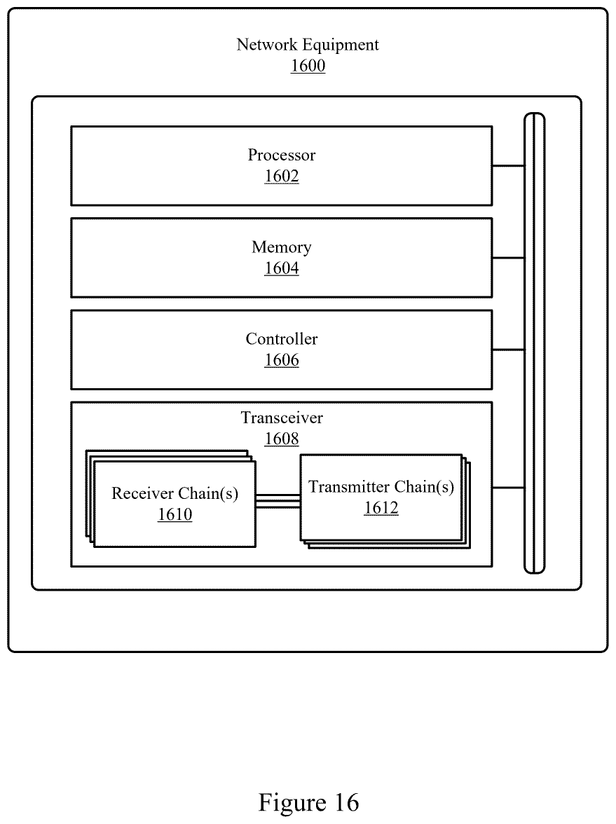

FIG. 16 illustrates an example of an NE 1600 in accordance with aspects of the present disclosure. The NE 1600 may include a processor 1602, a memory 1604, a controller 1606, and a transceiver 1608. The processor 1602, the memory 1604, the controller 1606, or the transceiver 1608, or various combinations thereof or various components thereof may be examples of means for performing various aspects of the present disclosure as described herein. These components may be coupled (e.g., operatively, communicatively, functionally, electronically, electrically) via one or more interfaces.

The processor 1602, the memory 1604, the controller 1606, or the transceiver 1608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1602 may include an intelligent hardware device (e.g., a general-purpose processor, a DSP, a CPU, an ASIC, an FPGA, or any combination thereof). In some implementations, the processor 1602 may be configured to operate the memory 1604. In some other implementations, the memory 1604 may be integrated into the processor 1602. The processor 1602 may be configured to execute computer-readable instructions stored in the memory 1604 to cause the NE 1600 to perform various functions of the present disclosure.

The memory 1604 may include volatile or non-volatile memory. The memory 1604 may store computer-readable, computer-executable code including instructions when executed by the processor 1602 cause the NE 1600 to perform various functions described herein. The code may be stored in a non-transitory computer-readable medium such as the memory 1604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1602 and the memory 1604 coupled with the processor 1602 may be configured to cause the NE 1600 to perform one or more of the functions described herein (e.g., executing, by the processor 1602, instructions stored in the memory 1604). For example, the processor 1602 may support wireless communication at the NE 1600 in accordance with examples as disclosed herein. The NE 1600 may be configured to or operable to support a means for transmitting signaling that indicates one or more density values associated with one or more DMRS symbols across a set of resources associated with a physical channel, where the physical channel is associated with a set of layers corresponding to a set of ports of the one or more DMRS symbols, and where the one or more density values correspond to respective portions of resources of the set of resources occupied by the one or more DMRS symbols and receiving or transmitting, via the physical channel, the one or more DMRS symbols based on the one or more density values.

Additionally, the NE 1600 may be configured to or operable to support any one or combination of the one or more density values include a frequency density value, and where the set of resources includes a set of RBs. Additionally, the NE 1600 may be configured to or operable to support the respective portions of the resources include alternating RBs of the set of RBs based on the frequency density value being one half. Additionally, the NE 1600 may be configured to or operable to support the one or more density values include a time density value, and where the set of resources includes a set of slots. Additionally, the NE 1600 may be configured to or operable to support the respective portions of the resources include alternating slots of the set of slots based on the time density value being one half. Additionally, the NE 1600 may be configured to or operable to support the signaling includes one or more parameters that indicate a presence of a DMRS symbol in the respective portions of resources of the set of resources, and where the signaling includes at least one of a DCI scheduling a PDSCH, a DCI scheduling a PUSCH, an SPS PDSCH trigger, a CG PUSCH trigger, a PDCCH configuration message, or a PUCCH configuration message.

Additionally, the NE 1600 may be configured to or operable to support means for receiving, prior to transmitting the signaling, additional signaling that indicates one or more parameters, where the one or more density values are based on the one or more parameters. Additionally, the NE 1600 may be configured to or operable to support the additional signaling includes a CSI report, and where the one or more parameters include at least one of a channel flatness factor or a channel coherence period across at least one of a time domain and a frequency domain. Additionally, the NE 1600 may be configured to or operable to support a density value of the one or more density values corresponds to a partitioning of the set of resources into two subsets of resources, and where a first subset of resources of the two subsets of resources includes a first numerical quantity of DMRS symbols per resource, and where a second subset of resources of the two subsets of resources includes a second numerical quantity of DMRS symbols per resource. Additionally, the NE 1600 may be configured to or operable to support a ratio of a numerical quantity of resources in the first subset of resources and a total numerical quantity of resources in the set of resources is based on the density value.

Additionally, the NE 1600 may be configured to or operable to support the signaling includes a QCL relationship that associates a first set of DMRS symbols in the first subset of resources with a second set of DMRS symbols in the second subset of resources, and where the QCL relationship is with respect to one or more characteristics including at least one of an average delay, a delay spread, a Doppler shift, a Doppler spread, a spatial transmit filter or a spatial receive filter. Additionally, the NE 1600 may be configured to or operable to support the first numerical quantity of DMRS symbols per resource associated with the first subset of resources is greater than the second numerical quantity of DMRS symbols per resource associated with the second subset of resources. Additionally, the NE 1600 may be configured to or operable to support the second numerical quantity of DMRS symbols per resource is zero. Additionally, the NE 1600 may be configured to support any one or combination of the second subset of resources includes a ZP DMRS, where symbols corresponding to the ZP DMRS in the second subset of resources are associated with DMRS symbols in the first subset of resources via a QCL relationship with respect to one or more characteristics, and where the one or more characteristics include at least one of an average delay, a delay spread, a Doppler shift, a Doppler spread, a spatial transmit filter, or a spatial receive filter.

Additionally, the NE 1600 may be configured to or operable to support means for transmitting feedback including a NACK corresponding to a received TB or receiving the feedback including a NACK corresponding to a transmitted TB and receiving or transmitting one or more additional DMRS symbols based on a default density value associated with the set of ports of the one or more DMRS symbol. Additionally, the NE 1600 may be configured to or operable to support the default density value is one. Additionally, the NE 1600 may be configured to or operable to support means for applying the default density value to the one or more additional DMRS symbols a time period after the feedback is transmitted or received. Additionally, the NE 1600 may be configured to or operable to support the physical channel is a PDSCH, a PDCCH, a PUSCH, or a PUCCH.

Additionally, or alternatively, the NE 1600 may support at least one memory (e.g., the memory 1604) and at least one processor (e.g., the processor 1602) coupled with the at least one memory and configured to cause the NE to transmit signaling that indicates one or more density values associated with one or more DMRS symbols across a set of resources associated with a physical channel, where the physical channel is associated with a set of layers corresponding to a set of ports of the one or more DMRS symbols, and where the one or more density values correspond to respective portions of resources of the set of resources occupied by the one or more DMRS symbols and receive or transmit, via the physical channel, the one or more DMRS symbols based on the one or more density values.

Additionally, the NE 1600 may be configured to support any one or combination of the one or more density values include a frequency density value, and where the set of resources includes a set of RBs. Additionally, the NE 1600 may be configured to support any one or combination of the respective portions of the resources include alternating RBs of the set of RBs based on the frequency density value being one half. Additionally, the NE 1600 may be configured to support any one or combination of the one or more density values include a time density value, and where the set of resources includes a set of slots. Additionally, the NE 1600 may be configured to support any one or combination of the respective portions of the resources include alternating slots of the set of slots based on the time density value being one half. Additionally, the NE 1600 may be configured to support any one or combination of the signaling includes one or more parameters that indicate a presence of a DMRS symbol in the respective portions of resources of the set of resources, and where the signaling includes at least one of a DCI scheduling a PDSCH, a DCI scheduling a PUSCH, an SPS PDSCH trigger, a CG PUSCH trigger, a PDCCH configuration message, or a PUCCH configuration message.

Additionally, the at least one processor may be further configured to cause the NE 1600 to receive, prior to transmitting the signaling, additional signaling that indicates one or more parameters, where the one or more density values are based on the one or more parameters. Additionally, the NE 1600 may be configured to support any one or combination of the additional signaling includes a CSI report, and where the one or more parameters include at least one of a channel flatness factor or a channel coherence period across at least one of a time domain and a frequency domain. Additionally, the NE 1600 may be configured to support any one or combination of a density value of the one or more density values corresponds to a partitioning of the set of resources into two subsets of resources, and where a first subset of resources of the two subsets of resources includes a first numerical quantity of DMRS symbols per resource, and where a second subset of resources of the two subsets of resources includes a second numerical quantity of DMRS symbols per resource. Additionally, the NE 1600 may be configured to support any one or combination of a ratio of a numerical quantity of resources in the first subset of resources and a total numerical quantity of resources in the set of resources is based on the density value.

Additionally, the NE 1600 may be configured to support any one or combination of the signaling includes a QCL relationship that associates a first set of DMRS symbols in the first subset of resources with a second set of DMRS symbols in the second subset of resources, and where the QCL relationship is with respect to one or more characteristics including at least one of an average delay, a delay spread, a Doppler shift, a Doppler spread, a spatial transmit filter or a spatial receive filter. Additionally, the NE 1600 may be configured to support any one or combination of the first numerical quantity of DMRS symbols per resource associated with the first subset of resources is greater than the second numerical quantity of DMRS symbols per resource associated with the second subset of resources. Additionally, the NE 1600 may be configured to support any one or combination of the second numerical quantity of DMRS symbols per resource is zero; the second subset of resources includes a ZP DMRS, where symbols corresponding to the ZP DMRS in the second subset of resources are associated with DMRS symbols in the first subset of resources via a QCL relationship with respect to one or more characteristics, and where the one or more characteristics include at least one of an average delay, a delay spread, a Doppler shift, a Doppler spread, a spatial transmit filter, or a spatial receive filter.

Additionally, the at least one processor may be further configured to cause the NE 1600 to transmit feedback including a NACK corresponding to a received TB or receive the feedback including a NACK corresponding to a transmitted TB and receive or transmit one or more additional DMRS symbols based on a default density value associated with the set of ports of the one or more DMRS symbol. Additionally, the NE 1600 may be configured to support any one or combination of the default density value is one. Additionally, the at least one processor may be further configured to cause the NE 1600 to apply the default density value to the one or more additional DMRS symbols a time period after the feedback is transmitted or received. Additionally, the NE 1600 may be configured to support any one or combination of the physical channel is a PDSCH, a PDCCH, a PUSCH, or a PUCCH.

The controller 1606 may manage input and output signals for the NE 1600. The controller 1606 may also manage peripherals not integrated into the NE 1600. In some implementations, the controller 1606 may utilize an operating system such as iOS®, ANDROID®, WINDOWS®, or other operating systems. In some implementations, the controller 1606 may be implemented as part of the processor 1602.

In some implementations, the NE 1600 may include at least one transceiver 1608. In some other implementations, the NE 1600 may have more than one transceiver 1608. The transceiver 1608 may represent a wireless transceiver. The transceiver 1608 may include one or more receiver chains 1610, one or more transmitter chains 1612, or a combination thereof.

A receiver chain 1610 may be configured to receive signals (e.g., control information, data, packets) over a wireless medium. For example, the receiver chain 1610 may include one or more antennas to receive a signal over the air or wireless medium. The receiver chain 1610 may include at least one amplifier (e.g., a low-noise amplifier (LNA)) configured to amplify the received signal. The receiver chain 1610 may include at least one demodulator configured to demodulate the receive signal and obtain the transmitted data by reversing the modulation technique applied during transmission of the signal. The receiver chain 1610 may include at least one decoder for decoding the demodulated signal to receive the transmitted data.

A transmitter chain 1612 may be configured to generate and transmit signals (e.g., control information, data, packets). The transmitter chain 1612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1612 may also include at least one power amplifier configured to amplify the modulated signal to an appropriate power level suitable for transmission over the wireless medium. The transmitter chain 1612 may also include one or more antennas for transmitting the amplified signal into the air or wireless medium.

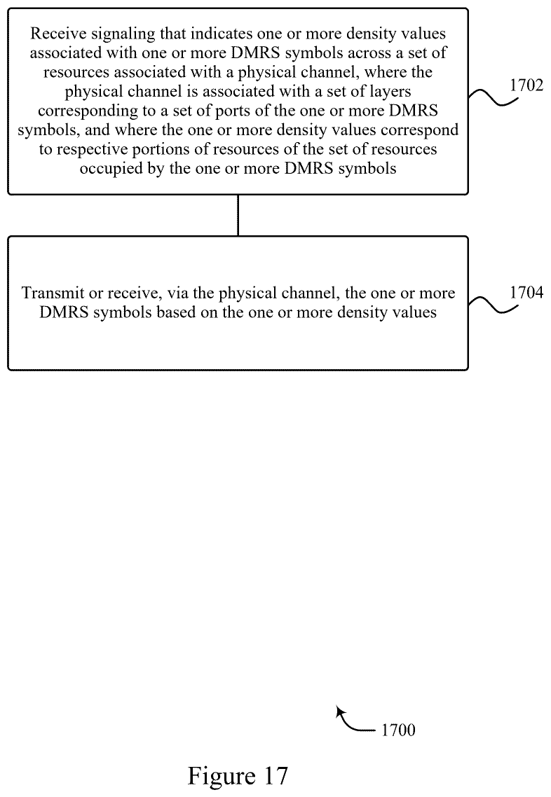

FIG. 17 illustrates a flowchart of a method 1700 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1702, the method may include receiving signaling that indicates one or more density values associated with one or more DMRS symbols across a set of resources associated with a physical channel, where the physical channel is associated with a set of layers corresponding to a set of ports of the one or more DMRS symbols, and where the one or more density values correspond to respective portions of resources of the set of resources occupied by the one or more DMRS symbols. The operations of 1702 may be performed in accordance with examples as described herein. In some implementations, aspects of the operations of 1702 may be performed by a UE as described with reference to FIG. 14.

At 1704, the method may include transmitting or receiving, via the physical channel, the one or more DMRS symbols based on the one or more density values. The operations of 1704 may be performed in accordance with examples as described herein. In some implementations, aspects of the operations of 1704 may be performed by a UE as described with reference to FIG. 14.

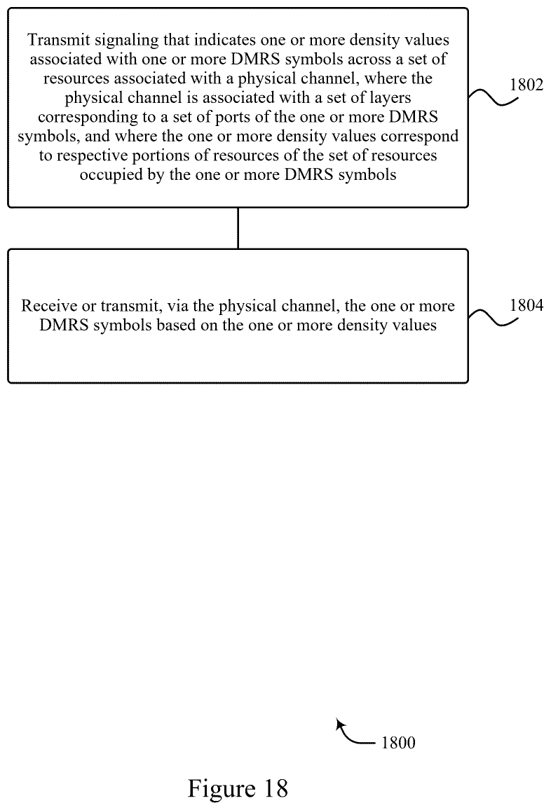

FIG. 18 illustrates a flowchart of a method 1800 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1802, the method may include transmitting signaling that indicates one or more density values associated with one or more DMRS symbols across a set of resources associated with a physical channel, where the physical channel is associated with a set of layers corresponding to a set of ports of the one or more DMRS symbols, and where the one or more density values correspond to respective portions of resources of the set of resources occupied by the one or more DMRS symbols. The operations of 1802 may be performed in accordance with examples as described herein. In some implementations, aspects of the operations of 1802 may be performed by an NE as described with reference to FIG. 16.

At 1804, the method may include receiving or transmitting, via the physical channel, the one or more DMRS symbols based on the one or more density values. The operations of 1804 may be performed in accordance with examples as described herein. In some implementations, aspects of the operations of 1804 may be performed by an NE as described with reference to FIG. 16.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive signaling that indicates one or more density values associated with one or more demodulation reference signal (DMRS) symbols across a plurality of resources associated with a physical channel, wherein the physical channel is associated with a plurality of layers corresponding to a plurality of ports of the one or more DMRS symbols, and wherein the one or more density values correspond to respective portions of resources of the plurality of resources occupied by the one or more DMRS symbols; and
transmit or receive, via the physical channel, the one or more DMRS symbols based at least in part on the one or more density values.

2. The UE of claim 1, wherein the one or more density values comprise a frequency density value, and wherein the plurality of resources comprises a plurality of resource blocks.

3. The UE of claim 2, wherein the respective portions of the resources comprise alternating resource blocks of the plurality of resource blocks based at least in part on the frequency density value being one half.

4. The UE of claim 1, wherein the one or more density values comprise a time density value, and wherein the plurality of resources comprises a plurality of slots.

5. The UE of claim 4, wherein the respective portions of the resources comprise alternating slots of the plurality of slots based at least in part on the time density value being one half.

6. The UE of claim 1, wherein the signaling comprises one or more parameters that indicate a presence of a DMRS symbol in the respective portions of resources of the plurality of resources, and wherein the signaling comprises at least one of a downlink control information (DCI) scheduling a physical downlink shared channel (PDSCH), a DCI scheduling a physical uplink shared channel (PUSCH), a semi-persistent scheduling (SPS) PDSCH trigger, a configured grant (CG) PUSCH trigger, a physical downlink control channel (PDCCH) configuration message, or a physical uplink control channel (PUCCH) configuration message.

7. The UE of claim 1, wherein the at least one processor is further configured to cause the UE to transmit, prior to receiving the signaling, additional signaling that indicates one or more parameters, wherein the one or more density values are based at least in part on the one or more parameters.

8. The UE of claim 7, wherein the additional signaling comprises a channel state information (CSI) report, and wherein the one or more parameters comprise at least one of a channel flatness factor or a channel coherence period across at least one of a time domain and a frequency domain.

9. The UE of claim 1, wherein a density value of the one or more density values corresponds to a partitioning of the plurality of resources into two subsets of resources, and wherein a first subset of resources of the two subsets of resources comprises a first numerical quantity of DMRS symbols per resource, and wherein a second subset of resources of the two subsets of resources comprises a second numerical quantity of DMRS symbols per resource.

10. The UE of claim 9, wherein a ratio of a numerical quantity of resources in the first subset of resources and a total numerical quantity of resources in the plurality of resources is based at least in part on the density value.

11. The UE of claim 9, wherein the signaling comprises a quasi-colocation (QCL) relationship that associates a first set of DMRS symbols in the first subset of resources with a second set of DMRS symbols in the second subset of resources, and wherein the QCL relationship is with respect to one or more characteristics comprising at least one of an average delay, a delay spread, a Doppler shift, a Doppler spread, a spatial transmit filter or a spatial receive filter.

12. The UE of claim 9, wherein the first numerical quantity of DMRS symbols per resource associated with the first subset of resources is greater than the second numerical quantity of DMRS symbols per resource associated with the second subset of resources.

13. The UE of claim 9, wherein the second numerical quantity of DMRS symbols per resource is zero.

14. The UE of claim 13, wherein the second subset of resources comprises a zero power (ZP) DMRS, wherein symbols corresponding to the ZP DMRS in the second subset of resources are associated with DMRS symbols in the first subset of resources via a quasi-colocation (QCL) relationship with respect to one or more characteristics, and wherein the one or more characteristics comprise at least one of an average delay, a delay spread, a Doppler shift, a Doppler spread, a spatial transmit filter, or a spatial receive filter.

15. The UE of claim 1, wherein the at least one processor is further configured to cause the UE to:
receive feedback comprising a negative acknowledgement (NACK) corresponding to a transmitted transport block; or
transmit the feedback comprising the NACK corresponding to a received transport block; and
transmit or receive one or more additional DMRS symbols based at least in part on a default density value associated with the plurality of ports of the one or more DMRS symbols.

16. The UE of claim 15, wherein the default density value is one.

17. The UE of claim 15, wherein the at least one processor is further configured to cause the UE to apply the default density value to the one or more additional DMRS symbols a time period after the feedback is received or transmitted.

18. A processor for wireless communication, comprising:
at least one controller coupled with at least one memory and configured to cause the processor to:
receive signaling that indicates one or more density values associated with one or more demodulation reference signal (DMRS) symbols across a plurality of resources associated with a physical channel, wherein the physical channel is associated with a plurality of layers corresponding to a plurality of ports of the one or more DMRS symbols, and wherein the one or more density values correspond to respective portions of resources of the plurality of resources occupied by the one or more DMRS symbols; and
transmit or receive, via the physical channel, the one or more DMRS symbols based at least in part on the one or more density values.

19. A method performed by a user equipment (UE), the method comprising:
receiving signaling that indicates one or more density values associated with one or more demodulation reference signal (DMRS) symbols across a plurality of resources associated with a physical channel, wherein the physical channel is associated with a plurality of layers corresponding to a plurality of ports of the one or more DMRS symbols, and wherein the one or more density values correspond to respective portions of resources of the plurality of resources occupied by the one or more DMRS symbols; and
transmitting or receiving, via the physical channel, the one or more DMRS symbols based at least in part on the one or more density values.

20. A network equipment (NE) for wireless communication, comprising:
at least one memory; and
at least one processor coupled with the at least one memory and configured to cause the NE to:
transmit signaling that indicates one or more density values associated with one or more demodulation reference signal (DMRS) symbols across a plurality of resources associated with a physical channel, wherein the physical channel is associated with a plurality of layers corresponding to a plurality of ports of the one or more DMRS symbols, and wherein the one or more density values correspond to respective portions of resources of the plurality of resources occupied by the one or more DMRS symbols; and
receive or transmit, via the physical channel, the one or more DMRS symbols based at least in part on the one or more density values.
